(19) United States
(12) Patent Application Publication
(10) Pub. No.: US 2024/0166961 A1
(43) Pub. Date: May 23, 2024

(54) SYSTEMS AND METHODS FOR OLEFIN PRODUCTION IN ELECTRICALLY-HEATED CRACKING FURNACE

(71) Applicant: SABIC GLOBAL TECHNOLOGIES B.V., BERGEN OP ZOOM (NL)

(72) Inventors: Christoph Johannes DITTRICH, Bangalore (IN); Arno Johannes Maria OPRINS, Bangalore (IN)

(73) Assignee: SABIC GLOBAL TECHNOLOGIES B.V., BERGEN OP ZOOM (NL)

(21) Appl. No.: 18/551,705

(22) PCT Filed: Mar. 21, 2022
(86) PCT No.: PCT/EP2022/057311

§ 371 Date: Sep. 21, 2023

(30) Foreign Application Priority Data
Mar. 24, 2021 (EP) 21164732.6

(51) Int. Cl. C10G 69/06; C09C 1/48

(52) U.S. Cl. CPC C10G 69/06; C09C 1/48; C10G 2300/4043; C10G 2300/4081; C10G 2400/20; C10G 2400/22

(57) ABSTRACT

A system and method to produce olefins may include one or more pre-heating assemblies to heat one or more of a hydrocarbon feed or dilution steam, and one or more cracking furnaces in flow communication with at least one of the pre-heating assemblies. At least one of the cracking furnaces may be at least partially powered by electricity or hydrogen to generate heat to at least partially crack the hydrocarbon feed into at least partially cracked hydrocarbons including olefins and methane. The system further may include one or more pyrolyzers to separate methane from the at least partially cracked hydrocarbons into carbon black and hydrogen. The system still further may include one or more converters to convert hydrogen into electricity. The systems and methods may result in more efficient production of olefins and relatively reduced emission of carbon dioxide.

### TECHNICAL FIELD

The present disclosure relates to systems and methods for producing olefins in electrically-heated cracking furnaces and, more particularly, to systems and methods for producing olefins from hydrocarbons in electrically-heated cracking furnaces with reduced CO₂ emission.

### BACKGROUND

Steam cracking of hydrocarbon feedstock in a gas-fired steam cracking furnace is a common method for producing olefins. In such methods, natural gas and light gas containing, for example, methane, hydrogen, carbon monoxide, and acetylene may be combusted in the gas-fired steam cracking furnace to provide heat for endothermic cracking reactions common in olefin production methods. Combustion of the hydrocarbons in the gas-fired steam cracking furnace forms carbon dioxide, which is emitted as part of flue gas from the gas-fired steam cracking furnace. Such emissions may be undesirable in view of current environmental considerations. Olefins are a major chemical building block and may often be produced in large quantities, such as several hundred thousand tons or more per year at a single olefin production facility. As a result, the production of olefins using gas-fired steam cracking furnaces may result in an undesirably high emission of carbon dioxide.

In addition, methane is a by-product of steam cracking of hydrocarbon feedstock and may be combusted in the gas-fired steam cracking furnaces of common olefin production methods. If not used as fuel in common olefin production methods, it may be combusted to perform work, but combustion of methane results in the emission of carbon dioxide, thus at least partially offsetting any efficiency gains provided by capturing and combusting the methane. Another possible use for the methane to reduce its negative effects is use of the methane in steam reforming to form syngas, which is a mixture of carbon monoxide and hydrogen. The syngas may be converted into useful products, such as methanol or hydrocarbons. However, the amount of methane formed from a typical olefin production facility may be insufficient for economically viable production of syngas and its derivatives. Additionally, the conversion of methane into syngas is endothermic and may be typically performed in reactors heated by the combustion of fuel, which, in turn, may generate more carbon dioxide. Thus, methane has typically been viewed as an unavoidable by-product of olefin production, and its use or disposal may lead to additional expense or undesirable environmental effects.

In addition, during olefin production using gas-fired steam cracking furnaces, hydrogen may typically be separated from methane in a cryogenic separation section of the steam cracking furnaces and obtained at a purity of about 80 mol % to about 95 mol % for further use in hydrogenations related to the olefin production process. A pressure-swing adsorption unit (PSA) may be used to increase the purity of the hydrogen, which may be necessary for using the hydrogen for other purposes. However, installation of cryogenic separators and PSAs may require additional expense, and further, require further energy inputs for operation.

An attempt to improve a method for steam cracking hydrocarbons to produce olefins is described in U.S. Pat. No. 7,288,690 to Bellet et al. (“the '690 patent”). The '690 patent describes methods for steam cracking hydrocarbons including heating a mixture of hydrocarbons and steam to transform the hydrocarbons into olefins. The '690 patent describes combustion of a fuel for cogeneration of heat energy and electricity, using the heat energy to preheat the hydrocarbons and steam, and using the electricity for electrical heating.

Applicant has recognized that the methods of '690 patent may still result in a need for systems and methods for producing olefins from hydrocarbons that are more efficient and/or more environmentally friendly. For example, although the methods described in the '690 patent may provide gains in efficiency, they may still be less efficient than desired, and further, the methods described in the '690 patent may result in an undesirably high emission of carbon dioxide.

Accordingly, Applicant has recognized a need for systems and methods for producing olefins from hydrocarbons that are more efficient and/or more environmentally friendly. The present disclosure may address one or more of the above-referenced drawbacks, as well as other possible drawbacks.

### SUMMARY

The present disclosure is generally directed to systems and methods for producing olefins from hydrocarbons using electrically-powered cracking furnaces, such as an electrically-powered steam cracking furnace. For example, in some embodiments, a system may include an at least partially electrically-powered cracking furnace to crack a hydrocarbon feed into olefins and other by-products. In some embodiments, methane and hydrogen products from the cracking process may be fed into a pyrolyzer configured to convert the methane and hydrogen into carbon black and hydrogen. In some embodiments, hydrogen may be fed to a converter configured to convert the hydrogen into electricity. For example, the converter may include a fuel cell configured to convert hydrogen into electricity and/or a gas turbine connected to an electric generator configured to convert mechanical work provided by the gas turbine into electricity. The gas turbine may be configured to convert fuel, such as natural gas, biogas, and/or hydrogen into mechanical work. The converted electricity may be supplied to the electrically-powered cracking furnace, a quench, compression, and separation section configured to separate the cracking products, and/or the pyrolyzer. In some embodiments, heat from the pyrolyzer and/or the converter may be supplied to a pre-heating assembly configured to heat the hydrocarbon feed and/or dilution steam that may be fed into the cracking furnace. In some embodiments, the cracking furnace may be hydrogen-fired. Thus, at least some embodiments of the systems and methods may result in production of a relatively reduced amount of carbon dioxide, a relatively reduced amount of methane that is not used in the process, and/or a more efficient production of olefins.

According to some embodiments, a system to produce olefins may include one or more pre-heating assemblies to heat one or more of a hydrocarbon feed or dilution steam. The system also may include one or more cracking furnaces in flow communication with at least one of the one or more pre-heating assemblies. At least one of the one or more cracking furnaces may be at least partially powered by electricity to generate heat to at least partially crack the hydrocarbon feed into at least partially cracked hydrocarbons including olefins and methane. The system further may include one or more pyrolyzers in flow communication with at least one of the one or more cracking furnaces to separate methane from the at least partially cracked hydrocarbons into carbon black and hydrogen. The system still further may include one or more converters in flow communication with at least one of the one or more pyrolyzers. At least one of the one or more cracking furnaces may be at least partially powered by electricity and may be positioned to receive electricity from one or more of the one or more converters.

According to some embodiments, a method for producing olefins may include supplying a hydrocarbon feed and dilution steam to a pre-heating assembly, and heating the hydrocarbon feed and dilution steam via the pre-heating assembly to provide a heated hydrocarbon feed. The method also may include supplying the heated hydrocarbon feed to a cracking furnace at least partially powered by electricity to produce at least partially cracked hydrocarbons including olefins and methane. The method further may include compressing, condensing, and/or separating at least a portion of the at least partially cracked hydrocarbons to provide either a separate methane and a separate hydrogen stream or a mixed hydrogen and methane stream, and supplying the separate methane stream or the mixed methane and hydrogen stream to a pyrolyzer. The method still further may include producing carbon black and hydrogen from the methane and hydrogen stream via the pyrolyzer, and supplying hydrogen from the pyrolyzer to a converter to convert the hydrogen into electricity. The method also may include supplying electricity from the converter to the cracking furnace, and supplying heat from one or more of the pyrolyzer or the converter to the pre-heating assembly.

According to some embodiments, a system to produce olefins may include one or more pre-heating assemblies to heat one or more of a hydrocarbon feed or dilution steam, and one or more cracking furnaces in flow communication with at least one of the one or more pre-heating assemblies. At least one of the one or more cracking furnaces may be at least partially powered by hydrogen to generate heat to at least partially crack the hydrocarbon feed and/or the dilution steam into at least partially cracked hydrocarbons including olefins and methane. The system also may include one or more pyrolyzers in flow communication with at least one of the one or more cracking furnaces to split methane from the at least partially cracked hydrocarbons into carbon black and hydrogen. At least a portion of the hydrogen from the one or more pyrolyzers may be supplied to at least one of the one or more cracking furnaces as fuel.

According to some embodiments, a method for producing olefins may include supplying a hydrocarbon feed and dilution steam to a pre-heating assembly, and heating the hydrocarbon feed and dilution steam via the pre-heating assembly to provide a heated hydrocarbon feed. The method also may include supplying the heated hydrocarbon feed to a cracking furnace at least partially powered by hydrogen to produce at least partially cracked hydrocarbons including olefins and methane. The method further may include compressing, condensing, and/or separating at least a portion of the at least partially cracked hydrocarbons to provide either a separate methane stream and a separate hydrogen stream or a mixed hydrogen and methane stream, and supplying the separate methane stream or the mixed hydrogen and methane stream to a pyrolyzer to provide carbon black and hydrogen. The method still further may include supplying hydrogen from the pyrolyzer to the cracking furnace as fuel.

Still other aspects and advantages of these exemplary embodiments and other embodiments, are discussed in detail herein. Moreover, it is to be understood that both the foregoing information and the following detailed description provide merely illustrative examples of various aspects and embodiments, and are intended to provide an overview or framework for understanding the nature and character of the claimed aspects and embodiments. Accordingly, these and other objects, along with advantages and features of the present invention herein disclosed, will become apparent through reference to the following description and the accompanying drawings. Furthermore, it is to be understood that the features of the various embodiments described herein are not mutually exclusive and may exist in various combinations and permutations.

### BRIEF DESCRIPTION OF THE DRAWINGS

The accompanying drawings, which are included to provide a further understanding of the embodiments of the present disclosure, are incorporated in and constitute a part of this specification, illustrate embodiments of the present disclosure, and together with the detailed description, serve to explain principles of the embodiments discussed herein. No attempt is made to show structural details of this disclosure in more detail than can be necessary for a fundamental understanding of the embodiments discussed herein and the various ways in which they can be practiced. According to common practice, the various features of the drawings discussed below are not necessarily drawn to scale. Dimensions of various features and elements in the drawings can be expanded or reduced to more clearly illustrate embodiments of the disclosure.

FIG. 1 schematically illustrates a system for producing olefins from hydrocarbons according to embodiments of the disclosure.

FIG. 2 schematically illustrates a comparative example system for producing olefins from naphtha or ethane.

FIG. 3 schematically illustrates a system alternative to the comparative examples illustrated in FIG. 2 for producing olefins from naphtha or ethane.

FIG. 4 schematically illustrates a system for producing olefins from naphtha or ethane according to embodiments of the disclosure.

FIG. 5 schematically illustrates another system for producing olefins from naphtha or ethane according to embodiments of the disclosure.

FIG. 6 schematically illustrates a yet another system for producing olefins from naphtha or ethane according to embodiments of the disclosure.

FIG. 7 is a bar graph showing specific carbon dioxide formation and specific electricity demand for four examples for producing olefins from naphtha according to embodiments of the disclosure.

FIG. 8 is a bar graph showing specific carbon dioxide formation and specific electricity demand for four examples for producing olefins from ethane according to embodiments of the disclosure.

FIG. 9 schematically illustrates another system for producing olefins from hydrocarbons according to embodiments of the disclosure.

FIG. 10 schematically illustrates a system for producing olefins from naphtha or ethane consistent with the system of FIG. 9 according to embodiments of the disclosure.

FIG. 11 schematically illustrates another system for producing olefins from naphtha or ethane consistent with the system of FIG. 9 according to embodiments of the disclosure.

FIG. 12 is a bar graph showing specific fuel addition for the first and second comparative examples and the eleventh through fourteenth examples of FIGS. 10 and 11 according to embodiments of the disclosure.

### DETAILED DESCRIPTION

The drawings include like numerals to indicate like parts throughout the several views, the following description is provided as an enabling teaching of exemplary embodiments, and those skilled in the relevant art will recognize that many changes may be made to the embodiments described. It also will be apparent that some of the desired benefits of the embodiments described can be obtained by selecting some of the features of the embodiments without utilizing other features. Accordingly, those skilled in the art will recognize that many modifications and adaptations to the embodiments described are possible and may even be desirable in certain circumstances. Thus, the following description is provided as illustrative of the principles of the embodiments and not in limitation thereof.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to,” unless otherwise stated. Thus, the use of such terms is meant to encompass the items listed thereafter, and equivalents thereof, as well as additional items. The transitional phrases “consisting of” and “consisting essentially of,” are closed or semi-closed transitional phrases, respectively, with respect to any claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish claim elements.

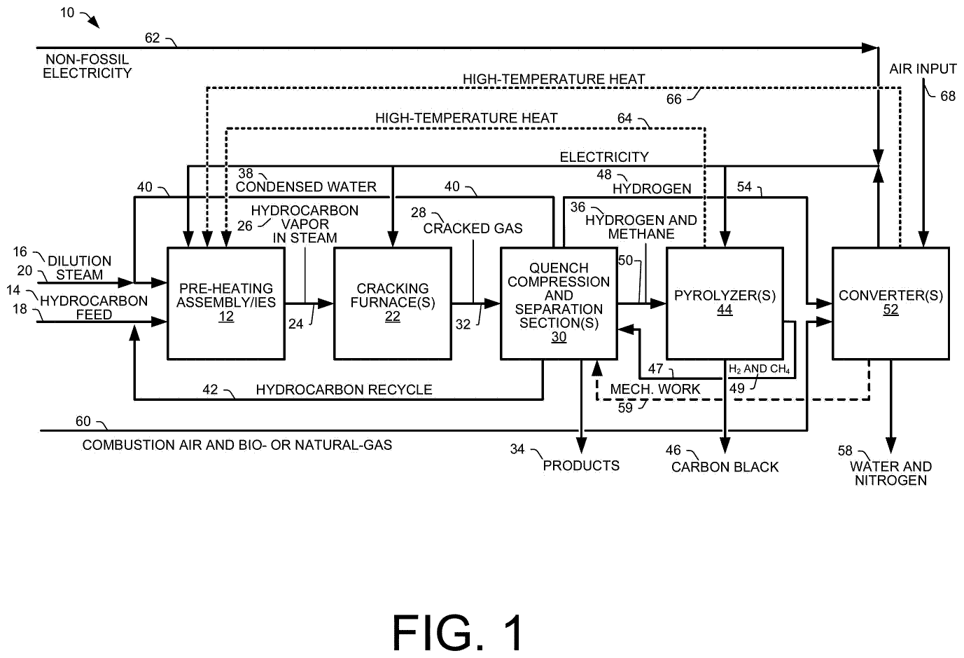

FIG. 1 schematically illustrates a system 10 for producing olefins from hydrocarbons according to embodiments of the disclosure. As shown in FIG. 1, in some embodiments, the system 10 may include one or more pre-heating assemblies 12 configured to heat a hydrocarbon feed 14 and/or dilution steam 16. For example, the system 10 may include a feed line 18 configured to supply the hydrocarbon feed 14 to the pre-heating assembly 12 and a dilution steam line 20 configured to supply the dilution steam 16 to the pre-heating assembly 12. In some embodiments, the hydrocarbon feed 14 may include naphtha, ethane, and/or other hydrocarbons, as will be understood by those skilled in the art. In some embodiments, the hydrocarbon feed 14 and the dilution steam 16 may be joined and/or mixed, for example, prior to entry into the pre-heating assembly 12 or after entering the pre-heating assembly 12, as will be understood by those skilled in the art.

As shown in FIG. 1, some embodiments of the system 10 may also include one or more cracking furnaces 22 in flow communication with the one or more pre-heating assemblies 12, for example, via a furnace line 24. For example, once the hydrocarbon feed 14 and dilution steam 16 have been heated in the pre-heating assembly 12, the hydrocarbon feed 14 and dilution steam 16 may take the form of hydrocarbon vapor in steam 26 and may be supplied to the steam cracking furnace 22 via the furnace line 24. In some embodiments, the steam cracking furnace 22 may be at least partially powered by electricity to power electric heaters and generate heat to at least partially crack (e.g., fully crack) the hydrocarbon vapor and steam 26 into at least partially cracked hydrocarbons. For example, the at least partially cracked hydrocarbon vapor may include cracked gas 28 including olefins, methane, and other by-products of the cracking process, as will be understood by those skilled in the art.

As shown in FIG. 1, some embodiments of the system 10 may also include one or more quench, compression, and separation sections 30 in flow communication with the one or more cracking furnaces 22. For example, a transfer line 32 may be provided between the cracking furnace 22 and the quench, compression, and separation section 30 to supply at least a portion of the cracked gas 28 to the quench, compression, and separation section 30. In some embodiments, the quench, compression, and separation section 30 may be configured to separate one or more components of the cracked gas 28 from one another. For example, the quench, compression, and separation section 30 may be configured to separate products 34 from the remainder of the cracked gas 28, including, for example, olefins, such as ethylene, propylene and butadiene, aromatics such as BTX, and gasoline and/or heavy oil. Other products are contemplated as will be understood by those skilled in the art. In some embodiments, the remainder of the cracked gas 28 may include by-products, such as, for example, methane and hydrogen 36 and/or condensed water 38. Other by-products are contemplated as will be understood by those skilled in the art. Some embodiments of the system 10 may include a water line 40 providing flow communication between the quench, compression, and separation section 30 and the dilution steam line 20 and/or the pre-heating assembly 12, for example, so that water separated from the cracked gas 28 by the quench, compression, and separation section 30 (e.g., the condensed water 38) may be supplied to the pre-heating assembly 12. As shown in FIG. 1, in some embodiments, the system 10 may include a hydrocarbon recycle line 42 configured to provide flow communication between the quench, compression, and separation section 30 and the hydrocarbon feed 14, and hydrocarbon by-products and unconverted hydrocarbons in the cracked gas 28 may be separated from other portions of the cracked gas 28 and recycled into the system 10, for example, at the hydrocarbon feed 14.

As shown in FIG. 1, some embodiments of the system 10 may include one or more pyrolyzers 44 in flow communication with the cracking furnace 22 to react methane from the cracked gas 28 into carbon black 46 and hydrogen 48. For example, the system 10 may include a pyrolyzer line 50 providing flow communication between the quench, compression, and separation section 30 and the pyrolyzer 44, and the hydrogen and methane 36 separated from the cracked gas 28 may be supplied from the quench, compression, and separation section 30 to the pyrolyzer 44, which may be configured to convert the hydrogen and methane 36 into carbon black 46 and hydrogen, for example, as shown in FIG. 1. The system 10 may include a return line 47 configured to supply hydrogen and methane 49 from the pyrolyzer 44 to the quench, compression, and separation section 30. Hydrogen and methane 49 returned to the quench, compression, and separation section 30 has a higher hydrogen content than hydrogen and methane 36 supplied to the pyrolyzer 44.

As shown in FIG. 1, some embodiments of the system 10 may also include one or more converters 52 in flow communication with the quench, compression, and separation section 30, for example, via a converter line 54 configured to supply hydrogen 48 to the converter 52. In some embodiments, the converters 52 may be configured to convert at least a portion of the hydrogen 48 supplied by the pyrolyzer 44 into electricity, for example, as described herein. The quench, compression, and separation section 30 may use at least a portion of the hydrogen as a reactant for operation of the quench, compression, and separation section 30. For example, the quench, compression, and separation section 30 may include one or more hydrogenation reactors in flow communication with the pyrolyzers 44, and the hydrogenation reactors may be configured to use as a reactant hydrogen received from the pyrolyzers 44.

As shown in FIG. 1, in some embodiments, electricity generated by the converters 52 may be supplied to the pre-heating assembly 12, the cracking furnace 22, and/or the pyrolyzers 44 for operation. In some embodiments, the converters 52 may be configured to at least partially output water and nitrogen 58, for example, as a by-product of converting hydrogen 48 into electricity, and in some embodiments, the water and nitrogen 58 may be recycled and used in at least a portion of the system 10. As shown, some embodiments of the converters 52 may be configured to output mechanical work 59, which may be supplied, for example, to the quench, compression, and separation section 30 to assist with operation of the quench, compression, and separation section 30.

In some embodiments, the converters 52 may include one or more fuel cells configured to convert hydrogen into electricity and/or one or more gas turbines, as explained herein. In some embodiments, the one or more fuel cells may include one or more solid-oxide fuel cells (SOFCs), although other types of fuel cells are contemplated. In some embodiments, the one or more gas turbines may be configured to produce mechanical work and may be connected, for example, via an output shaft and/or a transmission to one or more electric generators configured to convert at least a portion of the mechanical work supplied by the one or more gas turbines into electricity.

In some embodiments, as shown in FIG. 1, one or more of the converters 52 may include one or more gas turbines configured to convert into mechanical work (i) natural gas received from a natural gas source independent from the system 10 or (ii) biogas received from a biogas source independent from the system 10. For example, the system 10 may include a gas supply line 60 configured to provide flow communication between an external source of gas and the converters 52, as shown. This embodiment may be configured to output carbon dioxide together with water and nitrogen 58.

As shown in FIG. 1, some embodiments of the system 10 may be configured to receive electricity from a source outside the system 10 to replace and/or supplement electricity converted by the converters 52. For example, as shown, the system may include a power line 62 configured to provide electricity from an external electrical power source to the pre-heating assembly 12, the cracking furnace 22, and/or the pyrolyzers 44 for operation. In some examples, the external electric power source may be or include electricity generated from non-fossil sources and/or renewable sources of electricity.

In some embodiments, as shown in FIG. 1, the pre-heating assemblies 12 may be in flow communication with the pyrolyzers 44 and/or the converters 52, such that the pre-heating assemblies 12 may receive high-temperature heat from the pyrolyzers 44 and/or the converters 52. For example, as shown in FIG. 1, the system 10 may include one or more heat conduits 64 between the pyrolyzers 44 and the pre-heating assemblies 12 configured to supply high-temperature heat from operation of the pyrolyzers 44 to the pre-heating assemblies 12. The system 10 may also include one or more heat conduits 66 between the converters 52 and the pre-heating assemblies 12 configured to supply high-temperature heat from operation of the converters 52 to the pre-heating assemblies 12.

In some embodiments, as shown in FIG. 1, the system 10 may further include an air input 68 configured to supply air (e.g., ambient air including nitrogen and oxygen) to the converters 52. For example, the converters 52 may be configured to receive air via the air input 68 and convert as least a portion of the air into electricity, and water and nitrogen 58.

In some embodiments, the system 10 may include one or more controllers configured to control operation of the pre-heating assemblies 12, the cracking furnaces 22, the quench, compression, and separation sections 30, the pyrolyzers 44, and/or the converters 52, for example, as will be understood by those skilled in the art. For example, the system 10 may include a plurality of temperature sensors, pressure sensors, flow rate sensors, etc., in communication with the controller, and the controller may use control logic in the form of computer software and/or hardware programs to make control decisions associated with controlling operation of the pre-heating assemblies 12, the cracking furnaces 22, the quench, compression, and separation sections 30, the pyrolyzers 44, the converters 52, and/or components thereof. In some embodiments, the system 10 may include valves associated with the lines and/or conduits, and the controller may communicate control signals based at least in part on the control decisions to actuators associated with the valves to control the flow of fluid (e.g., gases and/or liquids) and/or heat, and the actuators may be operated according to the communicated control signals to operate the parts of the system 10. In some examples, the controller may be supplemented or replaced by human operators at least partially manually controlling the system 10 to meet desired performance parameters based at least in part on efficiency considerations and/or emissions considerations.

### COMPARATIVE EXAMPLES

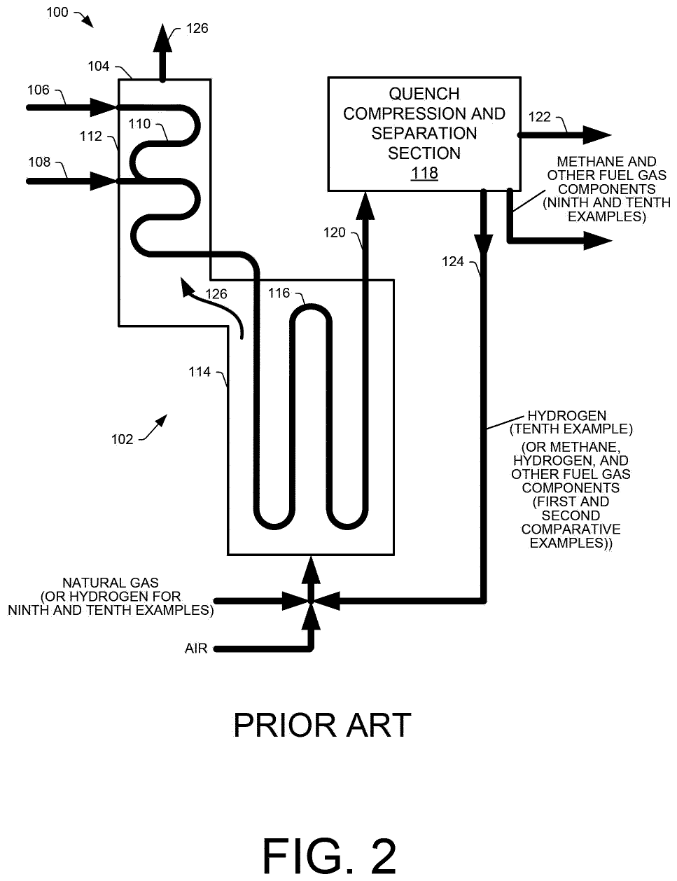

FIG. 2 schematically illustrates a first comparative example system 100 for producing olefins from hydrocarbons. As shown in FIG. 2, the first comparative example system 100 includes a gas-fired steam cracking furnace 102 heated by combustion of fuel, such as natural gas, to generate heat, which results in generation of carbon dioxide. The steam cracking furnace 102 shown in FIG. 2 includes a convection section 104 into which a hydrocarbon feed 106 and dilution steam 108 is supplied into pre-heating tubes 110 of a pre-heating section 112 for combining and pre-heating the hydrocarbon feed 106 and the dilution steam 108. The steam cracking furnace 102 also includes a radiation section 114, which combusts a hydrocarbon fuel to generate heat. The radiation section 114 includes cracking coils 116 through which the mixed and pre-heated hydrocarbon feed 106 and dilution steam 108 pass for heating (i.e., cracking) in the radiation section 114. The first comparative example system 100 also includes a quench, compression, and separation section 118, including a transfer line exchanger, a quench section, a compression section, and a cold separation section for separating a product mixture 120 received from the cracking coils 116 of the steam cracking furnace 102 into separated cracking products 122, excluding methane and hydrogen, and a fuel mixture of methane and hydrogen 124. The separated cracking products 122 include olefins and other products and may be supplied downstream for collection and/or further processing, as will be understood by those skilled in the art. The fuel mixture of methane and hydrogen 124 may be recycled back to the steam cracking furnace 102 for combustion to heat the radiation section 114 and the convection section 104, as shown in FIG. 2. Flue gas 126 resulting from combustion of fuel in the radiation section 114 of the steam cracking furnace 102, exits the system 100 via the convection section 104, as shown in FIG. 2. The flue gas 126 contains carbon dioxide and other by-products from combustion of the fuel.

In a first comparative example, the hydrocarbon feed 106 includes naphtha consisting of 36% normal-paraffins, 37% iso-paraffins, 21% naphthenes, and 6% aromatics is diluted with the dilution steam 108 in a ratio of 0.4 kilograms (kg) steam/kg naphtha, preheated to 650 degrees Celsius (C), and fed to cracking coils 116 of a steam cracking furnace 102 where it pyrolyzes at a coil outlet temperature of 800 degrees C. and a coil outlet pressure of 2 bar absolute. Table 1 below shows the composition of the effluent from the cracking coils 116 on a dry basis, in particular, the product slate of naphtha steam cracking on a dry basis for the first comparative example.

TABLE 1

| | Mass fraction | | Mass fraction |
|---|---|---|---|
| Component | [%] | Component | [%] |
| Hydrogen | 0.4 | Butadiene | 4.9 |
| Methane | 13.3 | Butenes | 6.0 |
| Acetylene | 0.3 | Butanes | 0.8 |
| Ethylene | 25.6 | Pyrolysis gasoline | 12.9 |
| Ethane | 4.4 | Benzene | 6.0 |
| Methyl acetylene | 0.6 | Toluene | 2.9 |
| and propadiene | | | |
| Propylene | 16.7 | Xylenes | 2.0 |
| Propane | 0.7 | Fuel oil | 2.5 |

In the first comparative example, the heat transferred in the cracking coils 116 to the pyrolyzing naphtha-steam mixture is equivalent to 2.26 megajoules per kilogram naphtha (MJ/kg naphtha). In order to raise the heat transferred to the cracking coils 116, methane may be combusted substantially adiabatically in a firebox of the steam cracking furnace 102, and flue gas 126 may be cooled to 1,200 degrees C. bridge wall temperature by transferring heat to the cracking coils 116. The flue gas 126 needs the combustion of 0.111 kg methane/kg naphtha, pre-mixed with air in slight excess for 1.5 vol-% oxygen in the flue gas 126 and accounting for 2% heat loss from the firebox, to meet the required heat duty. Table 1 above shows that enough methane may be produced by steam cracking to fulfill the fuel demand. The combusted methane forms 2.743 kg carbon dioxide/kg methane, equivalent to 0.303 kg carbon dioxide/kg naphtha. The flue gas 126 supplies 2.40 MJ/kg naphtha to evaporate the naphtha of the hydrocarbon feed 106 and preheat the naphtha-steam mixture to 650 degrees C. after it has been mixed with dilution steam 108 entering the pre-heating section 112 at 200 degrees C., and before flue gas 126 enters the cracking coils 116. The heat is supplied by cooling the hot flue gas 126 in the convection section 104 of the steam cracking furnace 102 shown in FIG. 2.

In a second comparative example consistent with the system 100 shown in FIG. 2, ethane is diluted with steam in a ratio of 0.3 kg steam/kg ethane, is preheated to 650 degrees C., and is fed to the cracking coils 116 of the gas-fired steam cracking furnace 102, where it pyrolyzes at a coil outlet temperature of 845 degrees C. and a coil outlet pressure of 2 bar absolute. The ethane conversion is 65%, and numerical results are referenced to the mass of ethane converted, abbreviated as “kg C₂ conv.” Table 2 below shows the composition of the effluent from the cracking coils 216 on a dry basis, in particular, the product slate of ethane steam cracking on a dry basis for the second comparative example. The numbers in brackets give the ultimate yields of the different products after recycling unconverted ethane to extinction.

TABLE 2

| Component | Mass fraction [%] | | Component | Mass fraction [%] |
|---|---|---|---|---|
| Hydrogen | 4.0 | (6.2) | Butadiene | 1.8 (2.8) |
| Methane | 3.8 | (5.8) | Butenes | 0.2 (0.3) |
| Acetylene | 0.4 | (0.7) | Butanes | 0.2 (0.3) |
| Ethylene | 52.1 | (80.1) | Pyrolysis gasoline | 0.4 (0.5) |
| Ethane | 35.0 | (—) | Benzene | 0.6 (0.8) |
| Propylene | 1.2 | (1.9) | Fuel oil | 0.2 (0.3) |
| Propane | 0.1 | (0.2) | | |

In the second comparative example, the heat transferred in the cracking coils 116 to the pyrolyzing ethane-steam mixture is equivalent to about 5.81 MJ/kg C₂ conv. In order to raise the heat transferred to the cracking coils 116, methane and hydrogen are combusted almost adiabatically in the firebox associated with the radiation section 114, and the flue gas 126 is cooled to 1,250 degrees C. bridge wall temperature by transferring heat to the cracking coils 116. The flue gas 126 needs the combustion of a fuel mixture of 0.056 kg hydrogen and 0.143 kg methane per kg ethane converted, pre-mixed with air in slight excess for 1.5 vol-% oxygen in the flue gas 126, and accounting for 2% heat losses from the firebox, to meet the required heat duty.

As shown in Table 2 above, the combusted hydrogen is equivalent to about 90% of the hydrogen by-product of ethane steam cracking. The remaining 10% are accounted for by hydrogenation of acetylene and pyrolysis gasoline, and for losses. Table 2 also shows that the generated methane is not sufficient to meet the fuel demand, and 0.085 kg natural gas/kg C₂ conv. here approximated as pure methane, needs to be imported to meet the demand. The combusted methane forms 2.743 kg CO₂/kg methane, which is equivalent to 0.391 kg CO₂/kg C₂ conv. The flue gas 126 supplies 3.19 MJ/kg C₂ conv. to preheat the ethane-steam mixture to 650 degrees C. after the ethane-steam mixture has been mixed with dilution steam at 200 degrees C. and before the ethane-steam mixture enters the cracking coils 116. The heat may be supplied by cooling hot flue gas 126 in the convection section 104 of the steam cracking furnace 102.

### Embodiments According to the Disclosure

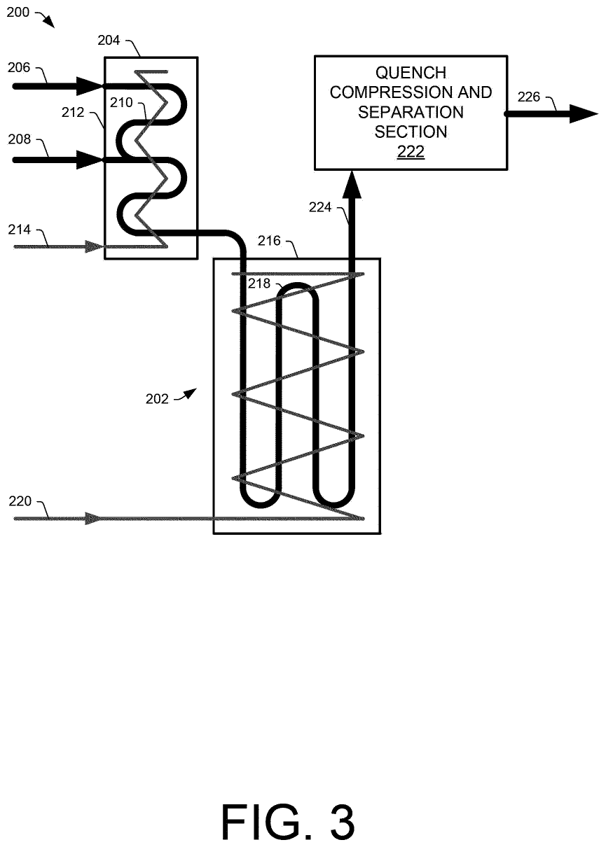

FIG. 3 schematically illustrates an alternative system 200 for producing olefins from hydrocarbons. As shown in FIG. 3, the embodiment of the system 200 shown in FIG. 3 includes an electrically-powered steam cracking furnace 202 heated by electrical heaters supplied with electrical power, for example, as explained below, to generate heat. The system 200 shown in FIG. 3 also includes a pre-heating section 204 into which a hydrocarbon feed 206 and dilution steam 208 is supplied into pre-heating tubes 210 of the pre-heating section 204 for combining and pre-heating the hydrocarbon feed 206 and the dilution steam 208. In some embodiments, the pre-heating section 204 includes a pre-heating chamber 212 containing the pre-heating tubes 210. In the embodiment of the system 200 shown in FIG. 3, electricity 214 may be supplied to electrical heaters in the pre-heating chamber 212 to heat the pre-heating tubes 210.

In some embodiments consistent with FIG. 3, the cracking furnace 202 may include a cracking heating chamber 216 containing cracking coils 218, and electrical heaters in the cracking heating chamber 216 may be supplied with electrical power 220 to heat the cracking coils 218. The mixed and pre-heated hydrocarbon feed 206 and dilution steam 208 pass through the cracking coils 218 in the cracking heating chamber 216 for being heated (i.e., cracked).

As shown in FIG. 3, the system 200 in some embodiments also may include a quench, compression, and separation section 222 including, for example, a transfer line exchanger, a quench section, a compression section, and a cold separation section for separating a product mixture 224 received from the cracking coils 218 of the steam cracking furnace 202 into separated cracking products 226. In some embodiments, methane and/or hydrogen may be separated from the separated cracking products. The separated cracking products 226 may include olefins and other products and may be supplied downstream for collection and/or further processing, as will be understood by those skilled in the art.

In a first example consistent with the embodiment of the system 200 shown in FIG. 3, the hydrocarbon feed 206 includes naphtha consisting of 36% normal-paraffins, 37% iso-paraffins, 22% naphthenes, and 6% aromatics is diluted with the dilution steam 208 in a ratio of 0.4 kilograms (kg) steam/kg naphtha, preheated to 650 degrees Celsius (C), and fed to cracking coils 218 of a steam cracking furnace 202 where it pyrolyzes at a coil outlet temperature of 800 degrees C. and a coil outlet pressure of 2 bar absolute. Table 1 above shows the composition of the effluent from the cracking coils 218 on a dry basis, in particular, the product slate of naphtha steam cracking on a dry basis for the first comparative example. The naphtha of the first example is cracked in the electrically-heated steam cracking furnace 202. Accounting for 2% heat loss from electrically powered high-temperature heating elements, the required electrical energy to heat the cracking coils 218 is 0.64 kWh electricity per kg naphtha (kWhel/kg naphtha). The electricity demand of the steam cracking furnace 202 for converting 24 tons per hour (t/h) naphtha is 15.4 MW, which would need to be imported into the olefin plant of the example system 200 shown in FIG. 3.

Electrically-heated cracking furnaces do not release hot flue gas, which is used in a gas-fired steam cracking furnace for evaporation of naphtha and preheating of the naphtha-steam mixture. If the naphtha-steam mixture is evaporated and preheated electrically too, it will require an additional 0.68 kWhel/kg naphtha of electricity, taking into account a 2% heat loss. This may be substantially equal to an additional 16.3 MW of electric power demand to operate the steam cracking furnace 202 to convert about 24 t/h of naphtha. If it is desired to produce olefins from naphtha with electrical heating and without carbon dioxide formation, up to 31.7 MW of electric power per steam cracking furnace 202 to convert 24 t/h of naphtha may need to be generated and imported to the system 200 of the embodiment shown in FIG. 3, for example, from renewable electricity sources. Some steam cracking operations may include as many as eight or more naphtha furnaces.

Referring again to embodiment of the system 200 shown in FIG. 3, in a second example, ethane is pyrolyzed in the electrically-heated steam cracking furnace 202 at the same pyrolysis conditions and with the same product slate (see Table 2 above) as described with respect to the second comparative example. Accounting for a 2% heat loss from the high-temperature heating elements, the required electrical energy to heat the cracking coils 218 is 1.65 kWhel/kg C₂ conv. The electricity demand of the steam cracking furnace 202 for converting 30 t/h ethane is 32.1 MW, which would need to be imported into the steam cracking furnace 202 of the olefin plant of the embodiment of the system 200 shown in FIG. 3.

As noted above with respect to the first example, electrically-heated cracking furnaces do not release hot flue gas, which may be used for evaporation and preheating of the ethane-steam mixture. If the ethane-steam mixture is preheated electrically, the system 200 will need an additional 0.90 kWhel/kg C₂ conv., taking into account for a 2% heat loss. This may be substantially equal to about an additional 17.6 MW electric power demand to operate the steam cracking furnace 202 to produce about 30 t/h of ethane. If it is desired to produce olefins from ethane with electrical heating and without carbon dioxide formation, up to 49.8 MW of electric power per steam cracking furnace to convert 30 t/h of ethane may need to be generated and imported into the system 200, for example, from renewable electricity sources. Some steam cracking operations may include as many as eight or more ethane cracking furnaces.

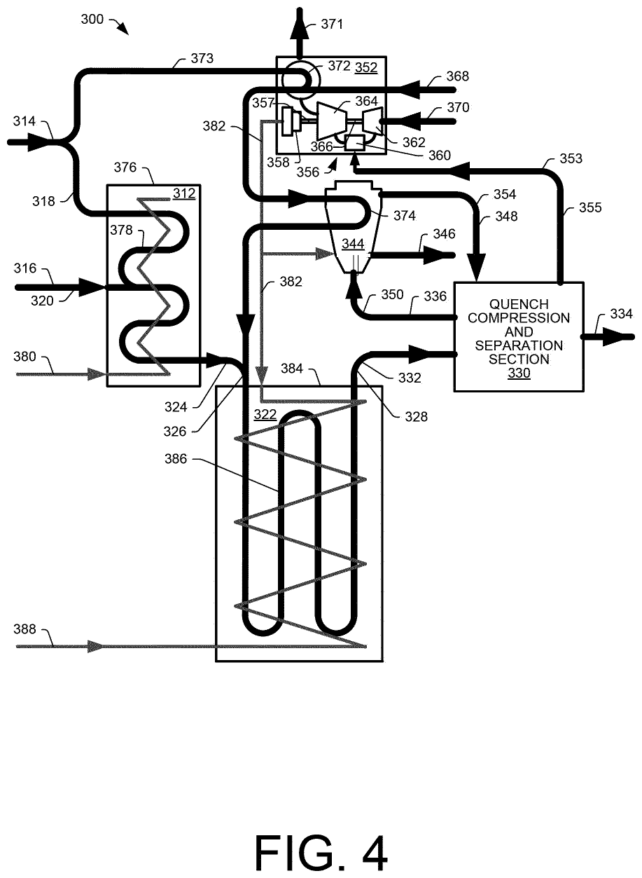

FIG. 4 schematically illustrates another system 300 for producing olefins from hydrocarbons according to embodiments of the disclosure. As shown in FIG. 4, some embodiments of the system 300 may include a pre-heating assembly 312 configured to receive a hydrocarbon feed 314 and dilution steam 316. A first portion of the hydrocarbon feed 314 may be supplied to the preheating assembly 312 via a first feed line 318, and the dilution steam 316 may be supplied to the pre-heating assembly via a dilution steam line 320. As shown in FIG. 4, the system 300 may include a steam cracking furnace 322, which is electrically-powered, for example, being heated by electrical heaters supplied with electricity. The hydrocarbon feed 314 may include naphtha, ethane, and/or other hydrocarbons, as will be understood by those skilled in the art. As shown in FIG. 4, in some embodiments, the first portion of the hydrocarbon feed 314 and the dilution steam 316 may be joined and/or mixed after entering the pre-heating assembly 312.

As shown in FIG. 4, some embodiments of the system 300 may also include a steam cracking furnace 322 in flow communication with the pre-heating assemblies 312, for example, via a furnace line 324. For example, once the first portion of the hydrocarbon feed 314 and dilution steam 316 have been heated in the pre-heating assembly 312, the hydrocarbon feed 314 and dilution steam 316 may take the form of hydrocarbon vapor in steam 326 and may be supplied to the steam cracking furnace 322 via the furnace line 324. In some embodiments, the steam cracking furnace 322 may be at least partially powered by electricity to generate heat to at least partially crack (e.g., fully crack) the hydrocarbon vapor and steam 326 into at least partially cracked hydrocarbons. For example, the at least partially cracked hydrocarbons may include cracked gas 328 including olefins, methane, and other by-products of the cracking process, as will be understood by those skilled in the art.

As shown in FIG. 4, some embodiments of the system 300 may also include a quench, compression, and separation section 330 in flow communication with the cracking furnace 322. For example, a gas line 332 may be provided between the cracking furnace 322 and the quench, compression, and separation section 330 to supply at least a portion of the cracked gas 328 to the quench, compression, and separation section 330. In some embodiments, the quench, compression, and separation section 330 may be configured to separate one or more components of the cracked gas 328 from one another. For example, the quench, compression, and separation section 330 may be configured to separate products 334 from the remainder of the cracked gas 328, including, for example, olefins, such as ethylene, propylene and butadiene, aromatics such as BTX, gasoline, and/or heavy oil. Other products are contemplated as will be understood by those skilled in the art. In some embodiments, the remainder of the cracked gas 328 may include by-products, such as, for example, methane and hydrogen 336 and/or water. Other by-products are contemplated as will be understood by those skilled in the art. In some embodiments, the quench, compression, and separation section 330 may include a transfer line exchanger, a quench section, and/or a compression and cold separation section, as will be understood by those skilled in the art. Some embodiments of the system 300 may include a water or steam line providing flow communication between the quench, compression, and separation section 330 and the dilution steam line 320 and/or the pre-heating assembly 312, for example, so that water separated from the cracked gas 328 by the quench, compression, and separation section 330 (e.g., the condensed water) may be supplied to the pre-heating assembly 312 (see, e.g., FIG. 1). In some embodiments, the system 300 may include a hydrocarbon recycle line configured to provide flow communication between the quench, compression, and separation section 330 and the hydrocarbon feed 314, and hydrocarbon by-products in the cracked gas 328 may be separated from other portions of the cracked gas 328 and recycled into the system 300 at the hydrocarbon feed 314 (see, e.g., FIG. 1).

As shown in FIG. 4, some embodiments of the system 300 may include a pyrolyzer 344 in flow communication with the cracking furnace 322 to split methane from the cracked gas 328 into carbon black 346 and hydrogen-rich gas 348. For example, the system 300 may include a pyrolyzer line 350 providing flow communication between the quench, compression, and separation section 330 and the pyrolyzer 344, and the hydrogen and methane 336 separated from the cracked gas 328 may be supplied from the quench, compression, and separation section 330 to the pyrolyzer 344, which may be configured to convert the hydrogen and methane 336 into carbon black 346 and hydrogen-rich gas 348, for example, as shown in FIG. 4. In some embodiments, the system 300 may include a pyrolyzer return line 354 to return the hydrogen-rich gas 348 from the pyrolyzer 344 to the quench, compression, and separation section 300 for further separation of hydrogen 355 from methane out of the hydrogen-rich gas 348.

As shown in FIG. 4, some embodiments of the system 300 may also include a converter 352 in flow communication with the quench, compression, and separation section 330, for example, via a converter line 353 configured to supply hydrogen 355 to the converter 352. In the system 300 shown in FIG. 4, the converter 352 may be configured to convert at least a portion of the hydrogen 355 supplied by the quench, compression, and separation section 330 into electricity, for example, as described herein. For example, the quench, quench, compression, and separation section 330 may include one or more hydrogenation reactors, and the hydrogenation reactors may be configured to use as a reactant hydrogen received from the pyrolyzer 344.

Although not shown in FIG. 4, in some embodiments of the system 300, electricity generated by the converter 352 may be supplied to the pre-heating assembly 312, for example, as shown in FIG. 1. As shown in FIG. 4, in some embodiments of the system 300, electricity generated by the converter 352 may be supplied to the cracking furnace 322 and/or the pyrolyzers 344 for operation. The converter 352 may be configured to at least partially output water and nitrogen, for example, as a by-product of converting hydrogen into electricity, and in some embodiments, the water may be recycled and used in at least a portion of the system 300 (see., e.g., FIG. 1). In some embodiments, the converter 352 may be configured to output mechanical work, which may be supplied, for example, to the quench, compression, and separation section 330 to assist with operation of the quench, compression, and separation section 330, for example, as shown in FIG. 1.

As shown in FIG. 4, the converter 352 includes a gas turbine 356 configured to produce mechanical work and may be connected, for example, via an output shaft 357 and/or a transmission to one or more electric generators 358 configured to convert at least a portion of the mechanical work supplied by the gas turbine 356 into electricity. The gas turbine 356 may include a combustor 360 for combusting fuel, a compressor 362 driven by a turbine 364 connected via a shaft 366. In some embodiments, the gas turbine 356 may be configured to receive hydrogen 355 from the quench, compression, and separation section, and/or air 370 from the environment surrounding the system 300 (e.g., ambient air including nitrogen and oxygen) for assisting with combustion in the combustor 360.

As shown in FIG. 4, in some embodiments, during operation of the gas turbine 356, mechanical work may be supplied to the electric generator 358 via the output shaft 357, and heat in the form of flue gas 371 from combustion may be used to pre-heat a second portion of the hydrocarbon feed 314 supplied via a second feed line 373 in low-temperature pre-heating coils 372 before the dilution steam 368 is mixed with the pre-heated second portion of the hydrocarbon feed 314 and the mixture passes into high-temperature pre-heating coils 374 associated with the pyrolyzer 344, where heat from operation of the pyrolyzer 344 may further heat the mixture of dilution steam 368 and the second portion of the hydrocarbon feed 314 being supplied to the cracking furnace 322.

In some embodiments, the gas turbine 356 may be configured to convert into mechanical work (i) natural gas received from a natural gas source independent from the system 300 and/or (ii) biogas received from a biogas source independent from the system 300, for example as shown in FIG. 1. For example, the system 300 may include a gas supply line configured to provide flow communication between an external source of gas and the gas turbine 356.

As shown in FIG. 4, in some embodiments of the system 300, the pre-heating assembly 312 may include a pre-heating chamber 376 through which preheating tubes 378 carrying the first portion of the hydrocarbon feed 314 and dilution steam 316 for mixing and/or pre-heating. The pre-heating chamber 376 may include electrically-powered heaters supplied with electricity via an electric power line 380. The combined and pre-heated first portion of hydrocarbon feed 314 and dilution steam 316 may be combined with the pre-heated second portion of hydrocarbon feed 314 and dilution steam 368 from the pyrolyzer 344, and the combined and pre-heated first and second portions of hydrocarbon feed 314 and dilution steam 316 and 368 may be supplied to the cracking furnace 322 for cracking the hydrocarbons from the hydrocarbon feed 314.

In the embodiment of the system 300 shown in FIG. 4, electricity generated by the converter 352 may be supplied via a converter power line 382 to electric heaters in a cracking heating chamber 384 of the cracking furnace 322. The electric heaters in the cracking heating chamber 384 may heat cracking coils 386 in the cracking furnace 322 through which the pre-heated first and second portions of hydrocarbons 314 and dilution steam 316 and 368 pass, thereby cracking the hydrocarbons to form cracking products 328, including olefins and by-products, such as methane and hydrogen. In some embodiments, electricity from an external source via an electric power line 388 may be supplied to replace or supplement the electricity supplied via the converter power line 382 from the converter 352. The cracking products 328 may be supplied to the quench, compression, and separation section 330, where the cracking products 328 may be at least partially separated from one another to provide separated cracking products 334. The separated cracking products 334 may include olefins and other products and may be supplied downstream for collection and/or further processing, as will be understood by those skilled in the art. In some embodiments, the fuel mixture of methane and hydrogen 336 may be supplied to the pyrolyzer 344, for example, as shown in FIG. 4.

In a third example consistent with the embodiment of system 300 shown in FIG. 4, naphtha is pyrolyzed in the steam cracking furnace 322, which is electrically powered. The cracking products 328 are separated in the quench, compression, and separation section 330. A fraction of about 48% of the separated by-product methane is supplied to the pyrolyzer 344, which may be an electrically-powered plasma methane pyrolyzer. The pyrolyzer 344 may require about 3.07 kWhel/kg methane, which is equivalent to about 0.196 kWhel/kg naphtha, to split the by-product methane into about 0.016 kg hydrogen and about 0.048 kg carbon black per kg naphtha, with an electrical efficiency of about 52%. An amount of heat of 0.34 MJ/kg naphtha is generated and may be recovered at about 1,000 degrees C.

In the third example, hydrogen from the pyrolyzer 344 may mixed with unconverted methane, for example, in order to obtain a gas-fuel mixture of about 35 vol-% methane and about 65 vol-% hydrogen, which may be fed to the gas turbine 356 coupled to the electric generator 358. The gas turbine 356 may operate at a pressure ratio of about 20 and about 2.9 times air excess, with about 85% polytropic efficiency of the compressor 362 of the gas turbine 356 and about 95% isentropic efficiency of the turbine 364 of the gas turbine 356. These example parameters, combined with about 98% shaft efficiency of the electric generator 358, may result in about a 41.4% gas turbine efficiency of conversion to electricity. The combustion of methane in the gas turbine 356 may generate about 0.189 kg CO₂/kg naphtha.

In the third example, the gas turbine 356 may convert a hydrogen-methane mixture into about 0.623 kWhel/kg naphtha electricity and an exhaust gas stream of about 565 degrees C., from which heat of about 2.34 MJ/kg naphtha may be recovered if cooled to about 160 degrees C. After subtraction of the electricity demand of the pyrolyzer 344, about 0.423 kWel/kg naphtha of electricity remains for heating the cracking furnace 322, which may reduce the demand for imported electricity (e.g., electricity generated independent from or outside the system 300).

It has been assumed for the purpose of calculation that the heat duties for pre-heating the feed to each of the pyrolyzer 344 and gas turbine 356 may be recovered from respective effluent streams, and pre-heating may thus be relatively neutral with respect to the heat balance. Other heat integration schemes with the same net heat from the pyrolyzer 344 and gas turbine 356 are contemplated.

Waste heat from the pyrolyzer 344 (at about 1000 degrees C.) and the gas turbine 356 (at about 565 degrees C.) may be used for evaporation of naphtha and/or preheating the naphtha-steam mixture fed to the cracking furnace 322. This may substantially or completely meet the heat demand of the pre-heating assembly 312, which may be equivalent to about 0.679 kWhel/kg naphtha, and no additional electricity may be needed for the pre-heating assembly 312. According to some embodiments consistent with this example, the total electricity demand of an electrically-powered steam cracking furnace 322 for converting about 24 t/h naphtha may be reduced from about 31.7 to about 5.1 MW, or by about 84%, and/or the specific carbon dioxide generation may be reduced from about 0.303 to about 0.188 kg carbon dioxide/kg naphtha, or by about 38%.

In a fourth example consistent with the embodiment of system 300 shown in FIG. 4, naphtha is pyrolyzed in an electrically-powered steam cracking furnace 322. As shown in FIG. 4, in this fourth example, the cracking products 328 may be separated by the quench, compression, and separation section 330. In some such examples, substantially all of the separated by-product methane may enter the pyrolyzer 344, which may be an electrically-driven plasma methane pyrolyzer. The pyrolyzer 344 may need about 3.07 kWhel/kg methane, which is equivalent to about 0.408 kWhel/kg naphtha, to split the by-product methane into about 0.033 kg hydrogen and about 0.099 kg carbon black per kg naphtha, for example, with an electrical efficiency of about 52%. An amount of heat of about 0.71 MJ/kg naphtha may be generated and may be substantially recovered at about 1,000 degrees C.

In the fourth example, hydrogen from the pyrolyzer 344 may be fed to the gas turbine 356, which may be modified for operating using hydrogen fuel and coupled to the electric generator 358. In such a configuration, the gas turbine 356 may operate at a pressure ratio of about 20 and about 3.3 times air excess, with about 85% polytropic efficiency of the compressor 362 of the gas turbine 356 and about 95% isentropic efficiency of the turbine 364 of the gas turbine 356. These example parameters, combined with about 98% shaft efficiency of the electric generator 358, may lead to about a 39.7% gas turbine efficiency of conversion to electricity. In the fourth example, substantially no carbon dioxide may be generated.

In the fourth example, the gas turbine 356 converts hydrogen into about 0.452 kWhel/kg naphtha electricity and an exhaust gas stream of about 565 degrees C., from which about 1.78 MJ/kg naphtha heat may be recovered if cooled to about 160 degrees C. After subtraction of the electricity demand of the pyrolyzer 344, 0.044 kWel/kg naphtha electricity remains for heating the cracking furnace 322 and reduces the demand for imported electricity (i.e., electricity provided by sources independent from the system 300).

In the fourth example, waste heat from the pyrolyzer 344 (at about 1,000 degrees C.) and the gas turbine 356 (at about 565 degrees C.) may be used for evaporation and/or preheating of the naphtha-steam mixture fed to the cracking furnace 322. This may substantially or completely cover the heat demand of the pre-heating assembly 312, which may be equivalent to about 0.679 kWhel/kg naphtha, and no additional electricity may be needed for preheating the naphtha-steam feed. The total electricity demand of the steam cracking furnace 322 of the fourth example for converting about 24 t/h naphtha may be reduced from about 31.7 to about 14.3 MW, or by about 55%, and the specific carbon dioxide generation by the olefin production may be reduced from about 0.303 to kg carbon dioxide/kg naphtha to about zero, or by about 100%.

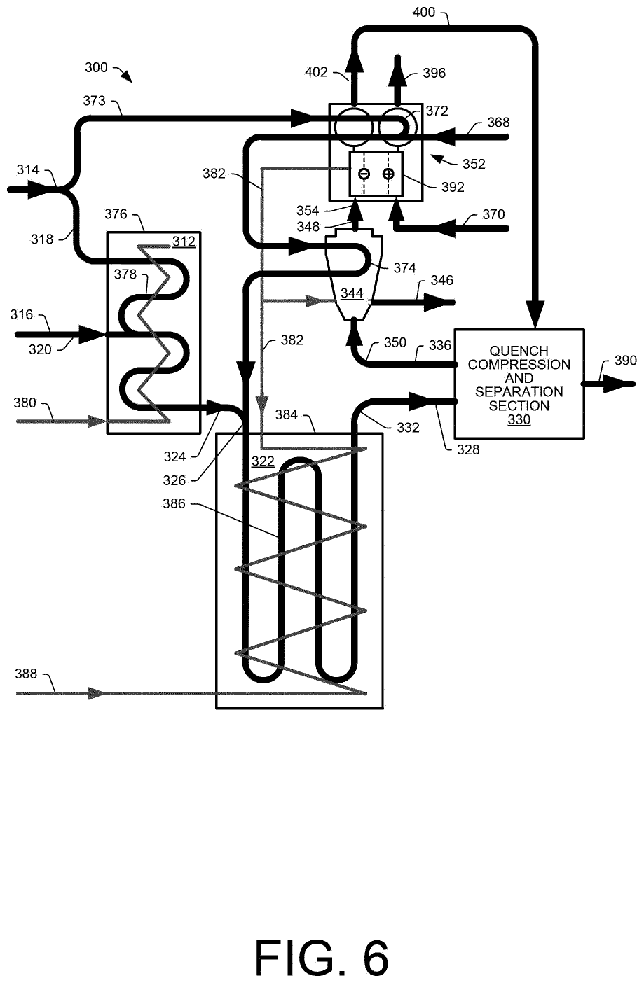

FIG. 6 schematically illustrates another system 300 for producing olefins from hydrocarbons according to embodiments of the disclosure. The system 300 shown in FIG. 6 is similar to the system 300 shown in FIG. 4, except the converter 352 in the embodiment shown in FIG. 6 includes a fuel cell 392 instead of a gas turbine 356 and electric generator 358. In some embodiments, the converter 352 may include one or more gas turbines and/or one or more fuel cells.

In a fifth example consistent with the embodiment of the system 300 shown in FIG. 6, the fuel cell 392 may be configured to convert hydrogen into electricity. For example, the fuel cell 392 may be a solid oxide fuel cell (SOFC) configured to be supplied with hydrogen-rich gas 348 from the pyrolyzer 344 along with air 370 from the environment surrounding the system 300 (e.g., ambient air including nitrogen and oxygen). The fuel cell 392 may be configured to convert the hydrogen 348 into electricity, which may be supplied to the pyrolyzer 344 for operation and/or to the cracking furnace 322 to heat the electric heaters, for example, as described above with respect to FIG. 4. The fuel cell 392 may output a mixture 402 of steam, hydrogen not converted in the fuel cell 392 and methane not converted in the pyrolyzer 344, and depleted air 396, for example, as shown in FIG. 6. The fuel cell 392 may return the mixture 402 of steam, hydrogen not converted in the fuel cell 392, and methane not converted in the pyrolyzer 344 to the quench, compression, and separation section 330 via a fuel cell return line 400, where steam may be condensed as water and separated from hydrogen and methane, and hydrogen not converted in the fuel cell 392, and methane not converted in the pyrolyzer 344 may be combined with hydrogen and methane separated out of the cracked gas 328 to form the hydrogen and methane stream 336 as feed for the pyrolyzer 344. In addition, heat from operation of the fuel cell 392 may be used to heat dilution steam 368 and the second portion of hydrocarbon feed 314, which may additionally be heated by the pyrolyzer 344 as shown in FIG. 6, before being combined with the pre-heated first portions of hydrocarbon feed 314 and dilution steam 316 exiting the pre-heating assembly 312, for example, in a manner at least similar to the manner discussed above with respect to FIG. 4.

In the fifth example, naphtha may be pyrolyzed in the electrically-powered steam cracking furnace 322. According to the fifth example, the cracking products 328 may be separated in the quench, compression, and separation section 330. Substantially all of the separated by-product methane may enter the pyrolyzer 344, which may be an electrically-powered plasma methane pyrolyzer. The pyrolyzer 344 may require about 3.07 kWhel/kg methane, which may be equivalent to about 0.408 kWhel/kg naphtha, to split the by-product methane into about 0.033 kg hydrogen and about 0.099 kg carbon black per kg naphtha, for example, with an electrical efficiency of about 52%. An amount of heat of about 0.71 MJ/kg naphtha may be generated and may be recovered at about 1,000 degrees C.

In the fifth example, the converter 352 (e.g., the fuel cell 392) may convert the hydrogen portion of the hydrogen-rich gas 348 from the pyrolyzer 344 into electricity at about 500 degrees C., with an electrical efficiency of about 60%. The hydrogen portion of the hydrogen-rich gas 348 may generate about 0.684 kWhel/kg naphtha, and waste heat of about 1.64 MJ/kg naphtha in the fuel cell 392. Substantially no carbon dioxide may be generated according to the fifth example. After subtraction of the electricity demand of the pyrolyzer 344, about 0.044 kWhel/kg naphtha may remain for powering the cracking furnace 322 and/or reducing the demand for imported electricity.

Waste heat from the pyrolyzer 344 (at about 1,000 degrees C.) and the fuel cell 392 (at about 500 degrees C.) may be used for evaporation of the second portion of naphtha feed and preheating of the naphtha-steam mixture fed to the cracking furnace 322 (see, e.g., FIG. 1). This may reduce the electricity demand of the pre-heating assembly 312 from about 0.679 to 0.014 kWhel/kg naphtha. The total electricity demand of an electrically-powered steam cracking furnace 322 for converting about 24 t/h naphtha may be reduced from about 31.7 to about 9.1 MW, or by about 71%, and/or the specific carbon dioxide generation may be reduced from about 0.303 kg carbon dioxide/kg naphtha to about zero, or by about 100%.

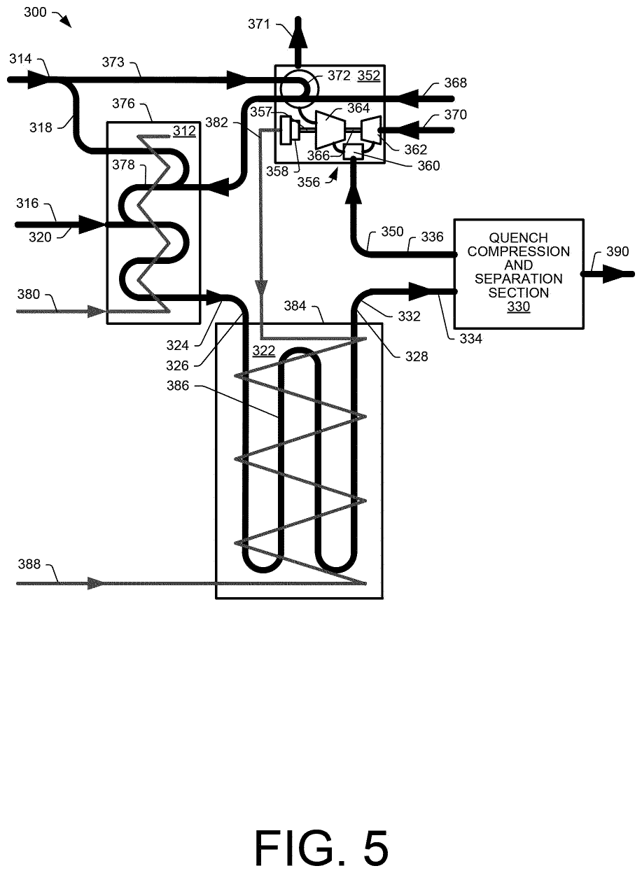

FIG. 5 schematically illustrates another embodiment of a system 300 for producing olefins from hydrocarbons according to embodiments of the disclosure. The embodiment of the system 300 shown in FIG. 5 is similar to the embodiment of the system 300 shown in FIG. 4, except the system 300 shown in FIG. 5 does not include a methane pyrolyzer. As a result, in some embodiments consistent with the system 300 shown in FIG. 5, electricity converted by the converter 352, a gas turbine 356 connected to an electric generator 358, is supplied to the electrically-powered steam cracking furnace 322, and is not supplied to a methane pyrolyzer. In addition, in the embodiment shown in FIG. 5, the dilution steam 368 and the second portion of hydrocarbon feed heated by the low-temperature pre-heating coils 372 may be combined with the first portion of hydrocarbon feed 314 and dilution steam 316 in the pre-heating chamber 376 of the pre-heating assembly 312 instead of after the pre-heated first portion of hydrocarbon feed 314 and dilution steam 316 exits the pre-heating chamber 376, for example, as shown in FIG. 4. As shown in FIG. 5, the quench, compression, and separation section 330 may output a fuel mixture 336 of methane and hydrogen that may be supplied to the gas turbine 356, where the fuel mixture 336 may be combusted to drive the electric generator 358.

In a sixth example consistent with the embodiment of the system 300 shown in FIG. 5, ethane may be cracked in the electrically-powered steam cracking furnace 322. The fuel mixture 336 of methane and hydrogen, a by-product of the cracking, may form a gas-fuel mixture of about 12 vol-% methane and about 88 vol-% hydrogen, which may be fed to the gas turbine 356, which may be modified for combustion of hydrogen fuel to drive the electric generator 358, for example, as shown in FIG. 5. The gas turbine 356 may operate at a pressure ratio of about 20 and about 3.1 times air excess, with about 85% polytropic efficiency of the compressor 362 of the gas turbine 356 and about 95% isentropic efficiency of the turbine 364 of the gas turbine 356. These example parameters, combined with about 98% shaft efficiency of the electric generator 358, may result in about a 39.7% gas turbine efficiency of conversion to electricity. The combustion of methane in the gas turbine 356 may generate about 0.148 kg CO₂/kg C₂ conv.

In the sixth example, the gas turbine 356 may convert the fuel mixture 336 of methane and hydrogen into about 1.076 kWhel/kg C₂ conv. electricity and an exhaust gas stream of about 565 degrees C., from which about 4.15 MJ/kg C₂ conv. of heat may be recovered, for example, if cooled to about 160 degrees C. Substantially all of the generated electricity may be used for powering electric heaters of the cracking furnace 322 and/or reducing the demand for imported electricity (e.g., electricity from a source independent of the system 300).

A portion of the waste heat from the gas turbine 356 (at about 565 degrees C.) may be used for pre-heating dilution steam 368 and the second portion of the ethane feed 314 fed to the cracking furnace 322. This may substantially meet approximately 75% of the heat demand of the pre-heating assembly 312, which may be equivalent to about 0.679 kWhel/kg C₂ conv., and only 0.226 kWhel/kg C₂ conv. additional electricity may be needed for pre-heating. The total electricity demand of an electrically-powered steam cracking furnace 322 for converting about 30 t/h ethane may be reduced from about 49.8 to about 15.5 MW, or by about 69%, and the specific carbon dioxide generation may be reduced from about 0.391 to about 0.148 kg CO₂/kg C₂ conv., or by about 62%.

In a seventh example consistent with the embodiment of the system 300 shown in in FIG. 4, ethane is cracked in an electrically-powered steam cracking furnace 322. The cracking products 328 may be separated in the quench, compression, and separation section 330, for example, as will be understood by those skilled in the art. Substantially all of methane separated from the cracking products by the quench, compression, and separation section 330 may be supplied to the pyrolyzer 344 (e.g., an electrically-driven plasma methane pyrolyzer), as shown in FIG. 4. The pyrolyzer 344 may need about 3.07 kWhel/kg methane, which may be equivalent to about 0.178 kWhel/kg C₂ conv., to split the methane into about 0.015 kg hydrogen and about 0.043 kg carbon black per kg ethane converted, for example, with an electrical efficiency of about 52%. An amount of heat of about 0.31 MJ/kg C₂ conv. may be generated and/or may be recovered at about 1,000 degrees C.

In the seventh example, hydrogen from the pyrolyzer 344 may be fed together with about 90% of hydrogen formed as a by-product during ethane cracking in the cracking furnace 322 to the gas turbine 356, which may be modified for combustion of hydrogen fuel to drive the electric generator 358, for example, as shown in FIG. 4. The gas turbine 356 may operate at a pressure ratio of about 20 and about 3.3 times air excess, with about 85% polytropic efficiency of the compressor 362 and about 95% isentropic efficiency of the turbine 364. These example parameters, combined with about 98% shaft efficiency of the electric generator 358, may result in about a 39.7% gas turbine efficiency for the conversion to electricity. Substantially no carbon dioxide may be generated.

In the seventh example, the gas turbine 356 may convert hydrogen into about 0.956 kWhel/kg C₂ conv. electricity and an exhaust gas stream of about 565 degrees C., from which about 3.75 MJ/kg C₂ conv. heat may be recovered if cooled to about 160 degrees C. After subtraction of the electricity demand of the pyrolyzer 344, about 0.788 kWhel/kg C₂ conv. electricity may remain for heating the cracking furnace 322 and/or reducing the demand for imported electricity.

In the seventh example, waste heat from the pyrolyzer 344 (at about 1,000 degrees C.) and the gas turbine 356 (at about 565 degrees C.) may be used for preheating the dilution steam 368 and the second portion of ethane 314 fed to the cracking furnace 322. This may substantially completely meet the heat demand of the pre-heating assembly 312, which may be equivalent to about 0.905 kWhel/kg C₂ conv., and little or no additional electricity may be needed for pre-heating. Substantially the total electricity demand of the electrically-powered steam cracking furnace 322 for converting about 30 t/h ethane may be reduced from about 49.8 to about 16.9 MW, or by about 66%, and/or the specific carbon dioxide generation may be reduced from about 0.392 kg CO₂/kg C₂ conv. to about zero, or by about 100%.

In an eighth example consistent with the embodiment of the system 300 shown in FIG. 6, ethane is cracked in an electrically-powered steam cracking furnace 322. The cracking products 328 may be separated in the quench, compression, and separation section 330, for example, as will be understood by those skilled in the art. Substantially all of the methane separated by the quench, compression, and separation section 330, a by-product of the cracking, may enter the pyrolyzer 344 (e.g., an electrically-driven plasma methane pyrolyzer), as shown in FIG. 6. The pyrolyzer 344 may need about 3.07 kWhel/kg methane, which may be equivalent to about 0.178 kWhel/kg C₂ conv., to split the methane into about 0.015 kg hydrogen and about 0.043 kg carbon black per kg ethane converted, with an electrical efficiency of about 52%. An amount of heat of about 0.31 MJ/kg C₂ conv. may be generated and may be recovered at about 1,000 degrees C.

In the eighth example, the fuel cell 392 (e.g., a solid-oxide fuel cell (SOFC)) may convert the hydrogen portion of the hydrogen-rich gas 348 from the pyrolyzer 344, together with about 90% of hydrogen by-product from the cracking, into electricity at about 500 degrees C., with an electrical efficiency of about 60%. About 0.070 kg hydrogen/kg C₂ conv. may generate electricity of about 1.444 kWhel/kg C₂ conv. and about 3.47 MJ/kg C₂ conv. heat. Substantially no carbon dioxide may be generated. After subtraction of the electricity demand of the pyrolyzer 344, about 1.266 kWel/kg C₂ conv. electricity may remain for heating the cracking furnace 322 and/or reducing the demand for imported electricity (e.g., electricity supplied by a source independent from the system 300).

In the eighth example, waste heat from the methane pyrolyzer (at about 1,000 degrees C.) and the fuel cell 392 (at about 500 degrees C.) may be used for pre-heating dilution steam 368 and the second portion of the ethane feed 314 fed to the cracking furnace 322. This may substantially completely meet the heat demand of the pre-heating assembly 312, which may be equivalent to about 0.905 kWhel/kg C₂ conv., and substantially no additional electricity may be needed for pre-heating. Substantially the total electricity demand of the electrically-powered steam cracking furnace 322 for converting about 30 t/h of ethane may be reduced from about 49.8 to about 7.4 MW, or by about 85%, and the specific carbon dioxide generation may be reduced from about 0.392 to kg carbon dioxide/kg C₂ conv. to substantially zero, or by about 100%.

Table 3 below provides summary of the specific electricity demand results for the first through eighth examples, all of which are provided in kWhel/kg naphtha or kWhel/kg C₂ conv.

TABLE 3

| | | | | Methane pyrolyzer | | Gas turbine or Fuel Cell | | |
|---|---|---|---|---|---|---|---|---|
| | | | Cracking | | Heat | | Heat | |
| | Number | Preheater | furnace | Consumed | equivalent | Generated | equivalent | Total |
| Examples | 1 | 0.679 | 0.640 | — | — | — | — | 1.319 |
| | 2 | 0.905 | 1.647 | — | — | — | — | 2.552 |
| | 3 | 0 | 0.640 | 0.196 | −0.094 | −0.623 | −0.585 | 0.214 |
| | 4 | 0 | 0.640 | 0.408 | −0.196 | −0.452 | −0.483 | 0.595 |
| | 5 | 0.014 | 0.640 | 0.408 | −0.196 | −0.684 | −0.456 | 0.378 |
| | 6 | 0.226 | 1.647 | — | — | −1.076 | −0.679 | 0.797 |
| | 7 | 0 | 1.647 | 0.178 | −0.085 | −0.956 | −0.819 | 0.869 |
| | 8 | 0 | 1.647 | 0.178 | −0.085 | −1.444 | −0.819 | 0.380 |

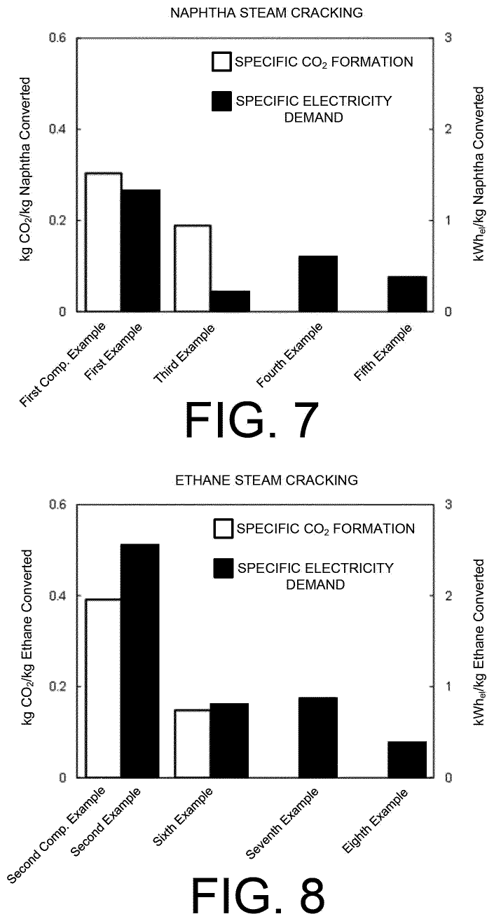

FIG. 7 is a bar graph showing specific carbon dioxide formation for the first comparative and third, fourth, and fifth examples, and specific electricity demand for the first, third, fourth, and fifth examples for producing olefins from naphtha in a manner consistent with the embodiments of the system shown in FIGS. 3-6. The specific electricity demands shown in FIGS. 7 and 8 are to be understood as specific demands of electricity to be generated outside of the systems 200 and 300, respectively, shown in FIGS. 3-6. As shown in FIG. 7, all three of the third through fifth examples are more efficient with respect to the specific electricity demand than the comparative first and first example, with the third example being the most efficient, followed by the fifth example and thereafter the fourth example. The systems of the third and fourth examples, each include the pyrolyzer 344 and the converter 352 including the gas turbine 356 driving the electric generator 358 (see FIG. 4), while the system of the fifth example includes the pyrolyzer 344 and the converter 352 including the fuel cell 392 (see FIG. 6). One difference between the third example and the fourth example is that in the fourth example, the gas turbine 356 has been modified to operate using hydrogen fuel, which may be supplied from the pyrolyzer 344.

Regarding the specific carbon dioxide emission, as shown in FIG. 7, all three of the third, fourth, and fifth examples form less carbon dioxide than the first comparative example with the fourth and fifth examples forming substantially no carbon dioxide, followed by the third example, which forms a relatively reduced amount of carbon dioxide as compared to the first comparative example.

FIG. 8 is a bar graph showing specific carbon dioxide formation for the second comparative and sixth, seventh and eighth example and specific electricity demand for the second, sixth, seventh, and eighth examples for producing olefins from ethane in a manner consistent with the embodiments of the system shown in FIGS. 3-6. As shown in FIG. 8, all three of the sixth through eighth examples are more efficient with respect to the specific electricity demand than the second example, with the eighth example being the most efficient followed by the sixth and seventh examples. The system of the eighth example includes the pyrolyzer 344 and the converter 352 including the fuel cell 392 (see FIG. 6). The system of the sixth example includes the converter 352 including the gas turbine 356, but not a pyrolyzer (see FIG. 5), while the system of the seventh example includes the pyrolyzer 344 and the converter 352 including the gas turbine 356 driving the electric generator 358 (see FIG. 4), and with the gas turbine 356 being modified to operate using hydrogen fuel, which may be supplied from the pyrolyzer 344.

Regarding the specific carbon dioxide emission, as shown in FIG. 8, all three of the sixth through eighth examples form less carbon dioxide than the second comparative example, with the seventh and eighth examples forming substantially no carbon dioxide, followed by the sixth example, which forms a relatively reduced amount of carbon dioxide as compared to the second comparative example.

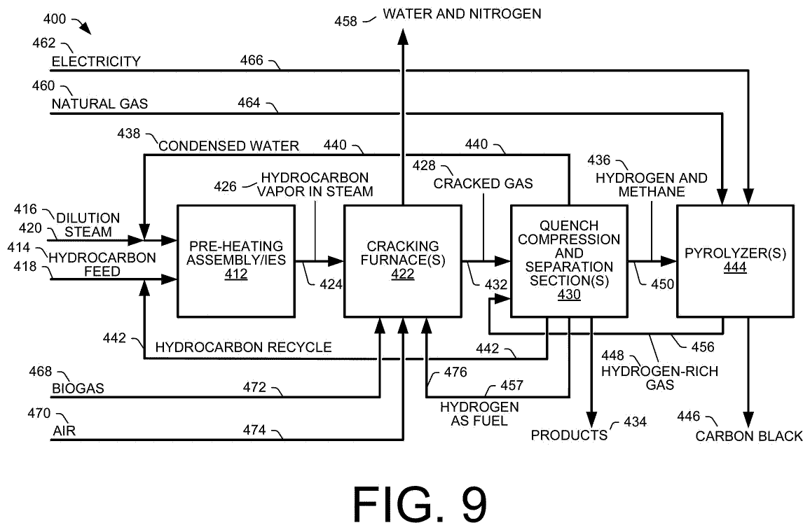

FIG. 9 schematically illustrates another system 400 for producing olefins from hydrocarbons (e.g., naphtha, butanes, propanes, and/or ethane) according to embodiments of the disclosure. As shown in FIG. 9, in some embodiments, the system 400 may include one or more pre-heating assemblies 412 configured to heat one or more of a hydrocarbon feed 414 and/or dilution steam 416. For example, the system 400 may include a feed line 418 configured to supply the hydrocarbon feed 414 to the pre-heating assembly 412 and a dilution steam line 420 configured to supply the dilution steam 416 to the pre-heating assembly 412. In some embodiments, the hydrocarbon feed 414 may include naphtha, ethane, and/or other hydrocarbons, as will be understood by those skilled in the art. In some embodiments, the hydrocarbon feed 414 and the dilution steam 416 may be joined and/or mixed, for example, prior to entry into the pre-heating assembly 412 or after entering the pre-heating assembly 412, as will be understood by those skilled in the art.

As shown in FIG. 9, some embodiments of the system 400 may also include one or more cracking furnaces 422 in flow communication with the one or more pre-heating assemblies 412, for example, via a furnace line 424. For example, once the hydrocarbon feed 414 and dilution steam 416 have been heated in the pre-heating assembly 412, the hydrocarbon feed 414 and dilution steam 416 may take the form of hydrocarbon vapor in steam 426 and may be supplied to the steam cracking furnace 422 via the furnace line 424. In some embodiments, the steam cracking furnace 422 may be at least partially heated by combustion of hydrogen to generate heat to at least partially crack (e.g., fully crack) the hydrocarbon vapor and steam 426 into at least partially cracked hydrocarbons. For example, the at least partially cracked hydrocarbon vapor may include cracked gas 428 including olefins, methane, hydrogen, and other by-products of the cracking process, as will be understood by those skilled in the art.

As shown in FIG. 9, some embodiments of the system 400 may also include one or more quench, compression, and separation sections 430 in flow communication with one or more of the cracking furnaces 422. For example, a transfer line 432 may be provided between the cracking furnace 422 and the quench, compression, and separation section 430 to supply at least a portion of the cracked gas 428 to the quench, compression, and separation section 430. In some embodiments, the quench, compression, and separation section 430 may be configured to separate one or more components of the cracked gas 428 from one another. For example, the quench, compression, and separation section 430 may be configured to separate products 434 from the remainder of the cracked gas 428, including, for example, olefins, such as ethylene, propylene and butadiene, aromatics such as BTX, and gasoline and/or heavy oil. Other products are contemplated as will be understood by those skilled in the art. In some embodiments, the remainder of the cracked gas 428 may include by-products, such as, for example, methane and hydrogen 436. Other by-products are contemplated as will be understood by those skilled in the art. Some embodiments of the system 400 may include a water line 440 providing flow communication between the quench, compression, and separation section 430 and the dilution steam line 420 and/or the pre-heating assembly 412, for example, so that water separated from the cracked gas 428 by the quench, compression, and separation section 430 (e.g., condensed water 438) may be supplied to the pre-heating assembly 412. As shown in FIG. 9, in some embodiments, the system 400 may include a hydrocarbon recycle line 442 configured to provide flow communication between the quench, compression, and separation section 430 and the hydrocarbon feed 414, and hydrocarbon by-products in the cracked gas 428 may be separated from other portions of the cracked gas 428 and recycled into the system 400 at the hydrocarbon feed 414.

As shown in FIG. 9, some embodiments of the system 400 may include one or more pyrolyzers 444 in flow communication with the cracking furnace 422 to split methane from the cracked gas 428 into carbon black 446 and hydrogen-rich gas 448. For example, the system 400 may include a pyrolyzer line 450 providing flow communication between the quench, compression, and separation section 430 and the pyrolyzer 444, and the hydrogen and methane 436 separated from the cracked gas 428 may be supplied from the quench, compression, and separation section 430 to the pyrolyzer 444, which may be configured to convert the methane and hydrogen 436 into carbon black 446 and hydrogen-rich gas 448, for example, as shown in FIG. 9.

As shown in FIG. 9, some embodiments of the system 400 may also include a hydrogen return line 456 providing flow communication between the output of the pyrolyzer 444 and the quench, compression, and separation section 430, which may return the hydrogen-rich gas 448 for further separation into hydrogen, and methane not converted in the pyrolyzer 444 to be mixed with methane and hydrogen 436 in the quench, compression, and separation section 430. The quench, compression, and separation section 430 may use at least a portion of the hydrogen separated out of the hydrogen-rich gas 448 as a reactant for operation of the quench, compression, and separation section 430. For example, the quench, compression, and separation section 430 may include one or more hydrogenation reactors in flow communication with the pyrolyzers 444, and the hydrogenation reactors may be configured to use as reactant hydrogen separated out of the hydrogen-rich gas 448 received from the pyrolyzer 444.

As shown in FIG. 9, in some embodiments, hydrogen 476 separated out of the hydrogen-rich gas 448 in the quench, compression and conversion section 430 may be supplied as fuel to the cracking furnace 422 for combustion via a fuel line 457. The cracking furnace 422 may be configured to at least partially output water and nitrogen 458, for example, as a by-product of combusting hydrogen 476 in the cracking furnace 422, and in some embodiments, water may be condensed out of water and nitrogen 458 may be recycled and used in at least a portion of the system 400.

In some embodiments, the system 400 may receive natural gas 460 and/or electricity 462 from sources independent from the system 400 (e.g., non-fossil electricity and/or electricity from renewable sources). For example, natural gas 460 may be supplied to the pyrolyzer 444 via a natural gas line 464, and/or electricity 462 may be supplied to the pyrolyzer 444 via an electric power line 466, for example, as shown in FIG. 9. In some embodiments, the system 400 may receive biogas 468 and/or air 470 (e.g., including nitrogen and oxygen) from sources independent from the system 400. For example, biogas 468 may be supplied to the cracking furnace 422 for use as fuel via a fuel line 472, and/or air 470 may be supplied to the cracking furnace 422 for combustion via an air line 474, for example, as shown in FIG. 9.

In some embodiments, the system 400 may include one or more controllers configured to control operation of the pre-heating assemblies 412, the cracking furnaces 422, the quench, compression, and separation sections 430, and/or the pyrolyzers 444, for example, as will be understood by those skilled in the art. For example, the system 400 may include a plurality of temperature sensors, pressure sensors, flow rate sensors, etc., in communication with the controllers, and the controllers may use control logic in the form of computer software and/or hardware programs to make control decisions associated with controlling operation of one or more of the pre-heating assemblies 412, the cracking furnaces 422, the quench, compression, and separation sections 430, the pyrolyzers 444, and/or components thereof. In some embodiments, the system 400 may include valves associated with the lines and/or conduits, and the controller may communicate control signals based at least in part on the control decisions to actuators associated with the valves to control the flow of fluid (e.g., gases and/or liquids) and/or heat, and the actuators may be operated according to the communicated control signals to operate the system 400. In some examples, the controller may be supplemented or replaced by human operators at least partially manually controlling the system 400 to meet desired performance parameters based at least in part on efficiency considerations and/or emissions considerations.

In a ninth example according to embodiments of the disclosure, naphtha may be steam-cracked in the system 100 for producing olefins from hydrocarbons shown in FIG. 2. In the ninth example, the steam cracking furnace 102 is heated by the combustion of hydrogen. The hydrocarbon feed 106 includes naphtha consisting of 36% normal-paraffins, 37% iso-paraffins, 21% naphthenes, and 6% aromatics, and is diluted with the dilution steam 108 in a ratio of about 0.4 kilograms (kg) steam/kg naphtha, preheated to about 650 degrees Celsius (C), and fed to cracking coils 116 of a steam cracking furnace 102 where it pyrolyzes at a coil outlet temperature of about 800 degrees C. and a coil outlet pressure of about 2 bar absolute. Accounting for about a 2% heat loss, the required hydrogen demand for combustion to heat the cracking coils is about 0.040 kg hydrogen/kg naphtha. Table 1 above shows the composition of the effluent from the cracking coils 116 on a dry basis, in particular, the product slate of naphtha steam cracking on a dry basis for the ninth example.

In the ninth example, the heat transferred in the cracking coils 116 to the pyrolyzing naphtha-steam mixture is equivalent to about 2.26 megajoules per kilogram naphtha (MJ/kg naphtha). In order to raise the heat transferred to the cracking coils 116, a sufficient amount of hydrogen needs to be combusted in the firebox of the steam cracking furnace 102, and the flue gas 126 may be cooled to about 1,200 degrees C. bridge wall temperature by transferring heat to the cracking coils 116. Because the combustion of hydrogen is used to heat the cracking coils 116 (e.g., rather than methane and/or other hydrocarbons), the flue gas 126 from the steam cracking furnace 102 released to the atmosphere contains carbon dioxide only in trace amounts, if at all. The hydrogen demand of a cracking furnace for cracking about 24 t/h naphtha feed is about 0.97 ton per hour (t/h), for which a relatively large portion may need to be supplied to the system 100 from a source independent from the system 100 or otherwise intentionally created, for example, on-site.

In a tenth example according to embodiments of the disclosure, ethane may be steam-cracked in the system 100 for producing olefins from hydrocarbons shown in FIG. 2. In the tenth example, the steam cracking furnace 102 is heated by the combustion of hydrogen. The hydrocarbon feed 106 includes ethane diluted with steam in a ratio of about 0.3 kg steam/kg ethane, is preheated to 650 degrees C., and is fed to the cracking coils 116 of the gas-fired steam cracking furnace 102, where it pyrolyzes at a coil outlet temperature of about 845 degrees C. and a coil outlet pressure of about 2 bar absolute. The ethane conversion is about 65%, and numerical results are referenced to the mass of ethane converted, abbreviated as “kg C₂ conv.” Table 2 above shows the composition of the effluent from the cracking coils 116 on a dry basis.

In the tenth example, the heat transferred to the pyrolyzing ethane-steam mixture in the cracking coils is equivalent to about 5.81 MJ/kg C₂ converted. In order to raise the heat transferred to the cracking coils, the hydrogen is combusted almost adiabatically in a firebox with the radiation section 114, and the flue gas 126 is cooled to about 1,250 degrees C. bridge wall temperature by transferring heat to the cracking coils 116. Accounting for about a 2% heat loss, the required hydrogen demand to heat the cracking coils is about 0.109 kg hydrogen/kg C₂ converted. Because the combustion of hydrogen is used to heat the cracking coils 116 (e.g., rather than methane and/or other hydrocarbons), the flue gas 126 from the steam cracking furnace 102 is released to the atmosphere and contains carbon dioxide only in trace amounts, if at all. The hydrogen demand of a cracking furnace for converting about 30 t/h ethane feed is about 2.12 t/h, of which 1.09 t/h (52%) may be hydrogen by-product for ethane cracking and separated in the quench, compression and separation section 118, and 1.03 t/h (48%) may need to be supplied to the system 100 from a source independent from the system 100 or otherwise intentionally created, for example, on-site.

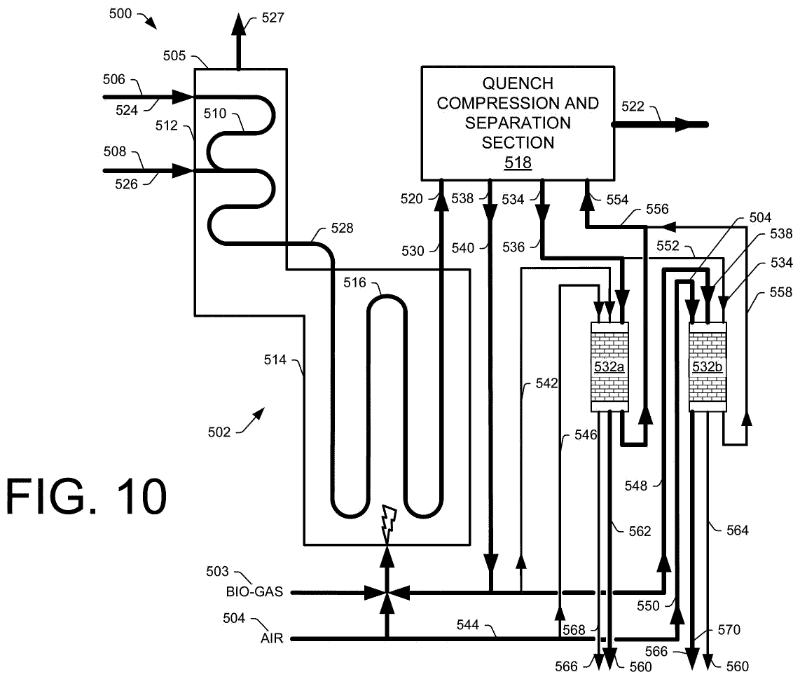

FIG. 10 schematically illustrates an example system 500 for producing olefins from naphtha or ethane consistent with the system of FIG. 9 according to embodiments of the disclosure. As shown in FIG. 10, the example system 500 includes a gas-fired steam cracking furnace 502 heated by combustion of fuel, such as, for example, bio-gas 503, hydrogen 540, and/or air 504 (e.g., oxygen and nitrogen) to generate heat. The steam cracking furnace 502 shown in FIG. 10 includes a convection section 505 into which a hydrocarbon feed 506 and dilution steam 508 is supplied into pre-heating tubes 510 of a pre-heating section 512 for combining and pre-heating the hydrocarbon feed 506 and the dilution steam 508. The steam cracking furnace 502 also includes a radiation section 514, which combusts fuel to generate heat. The radiation section 514 includes cracking coils 516 through which the mixed and pre-heated hydrocarbon feed 506 and dilution steam 508 pass for heating (i.e., cracking) in the radiation section 514. The example system 500 also includes a quench, compression, and separation section 518, including a transfer line exchanger, a quench section, a compression section, and a cold separation section for separating a product mixture 520 received from the cracking coils 516 of the steam cracking furnace 502 into separated cracking products 522, excluding, for example, hydrogen and methane. The separated cracking products 522 may include olefins and other products and may be supplied downstream for collection and/or further processing, as will be understood by those skilled in the art.

The example system 500 shown in FIG. 10 may include a feed line 524 configured to supply the hydrocarbon feed 506 to the pre-heating assembly 512 and a dilution steam line 526 configured to supply the dilution steam 508 to the pre-heating assembly 512. In some embodiments, the hydrocarbon feed 506 may include naphtha, ethane, and/or other hydrocarbons, as will be understood by those skilled in the art. In some embodiments, the hydrocarbon feed 506 and the dilution steam 508 may be joined and/or mixed, for example, prior to entry into the pre-heating assembly 512 or after entering the pre-heating assembly 512, as will be understood by those skilled in the art.

As shown in FIG. 10, some embodiments of the system 500 may also include a furnace line 528 providing flow communication between the pre-heating section 512 and the cracking furnace 502. For example, once the hydrocarbon feed 506 and dilution steam 508 have been heated in the pre-heating assembly 512, the hydrocarbon feed 506 and dilution steam 508 may take the form of hydrocarbon vapor in steam and may be supplied to the cracking furnace 502 via the furnace line 528. In some embodiments, the cracking furnace 502 may be at least partially heated by combustion of hydrogen and/or hydrocarbons to generate heat to at least partially crack (e.g., fully crack) the hydrocarbon vapor and steam into the product mixture 520, which may include at least partially cracked hydrocarbons. For example, the product mixture 520 may include cracked gas including olefins, methane, hydrogen, and other by-products of the cracking process, as will be understood by those skilled in the art.

As shown in FIG. 10, some embodiments of the system 500 may also include a transfer line 530 provided between the cracking furnace 502 and the quench, compression, and separation section 518 to supply at least a portion of the product mixture 520 to the quench, compression, and separation section 518. In some embodiments, the quench, compression, and separation section 518 may be configured to separate one or more components of the product mixture 520 from one another. For example, the quench, compression, and separation section 518 may be configured to separate the separated products 522 from the remainder of the product mixture 520, including, for example, olefins, such as ethylene, propylene and butadiene, aromatics such as BTX, and gasoline and/or heavy oil. Other products are contemplated as will be understood by those skilled in the art. In some embodiments, the remainder of the product mixture 520 may include by-products, such as, for example, methane and hydrogen. Other by-products are contemplated as will be understood by those skilled in the art.

As shown in FIG. 10, some embodiments of the system 500 may include one or more methane pyrolyzers in flow communication with the cracking furnace 502 to split methane from the cracked gas product mixture 520 (e.g., the cracked gas) into carbon black and hydrogen-rich gas. For example, the system 500 may include a first methane pyrolyzer 532a configured to operate in a methane splitting mode, and a second methane pyrolyzer 532b configured to operate in a re-heating mode. For example, as shown in FIG. 10, the first methane pyrolyzer 532a may be configured to receive methane or a hydrogen-methane mixture 534 from the quench, compression, and separation section 518 via a line 536, hydrogen fuel 538 for re-heating the first methane pyrolyzer 532a from the quench, compression, and separation section 518 via a line 540 and a line 542, and/or air 504 (e.g., oxygen and nitrogen) via an air feed line 544 and a line 546. As shown in FIG. 10, the second methane pyrolyzer 532b may be configured to receive hydrogen fuel 538 for re-heating the second methane pyrolyzer 532b from the quench, compression, and separation section 518 via a line 548, air 504 (e.g., oxygen and nitrogen) via the air feed line 544 and a line 550, and/or the methane or hydrogen-methane mixture 534 from the quench, compression, and separation section 518 via the line 536 and a line 552.

As shown in FIG. 10, the first methane pyrolyzer 532a may supply a hydrogen-rich, hydrogen-methane mixture 554 to the quench, compression, and separation section 518 via a line 556. The hydrogen-rich, hydrogen-methane mixture 554 may be separated into hydrogen and methane in the quench, compression, and separation section 518. Hydrogen separated out of hydrogen-rich gas 554 may be fed as hydrogen fuel 538 to line 540 and used as fuel to heat the cracking furnace 502 and the second methane pyrolyzer 532b. Methane separated out of the hydrogen-rich gas 554 may be mixed with the methane and hydrogen portion of the product mixture 520 in the quench, compression, and separation section 518, and fed as hydrogen-methane mixture 534 to the first methane pyrolyzer 532a. The first methane pyrolyzer 532a may output carbon black 560 via line 562. As shown in FIG. 10, the second methane pyrolyzer 532b may output flue gas 566 from the second methane pyrolyzer 532b in re-heating mode via line 568, respectively. FIG. 10 shows an example system 500 with a first methane pyrolyzer 532a in methane splitting mode and a second methane pyrolyzer 532b in re-heating mode. At different times, the same system 500 may work with the first methane pyrolyzer 532a in re-heating mode and the second methane pyrolyzer 532b in methane splitting mode (not shown in FIG. 10).

In an eleventh example according to embodiments of the disclosure and consistent with the example system 500 shown in FIG. 10, naphtha is cracked in the cracking furnace 502 for producing olefins from hydrocarbons. In the eleventh example, the cracking furnace 502 is heated by combustion of a mixture of hydrogen and bio-gas 503 (e.g., for example, bio-gas supplied from a source independent from (e.g., outside) the system 500). The product mixture 520 (e.g., the cracking products) output by the cracking furnace 502 are separated in the quench, compression, and separation section 518 of the system 500 (e.g., an olefins plant) as will be understood by those skilled in the art. Flue gas 527 from the cracking furnace 502 released to the atmosphere contains carbon dioxide, which results from combustion of the bio-gas 503.

In the eleventh example, the hydrocarbon feed 506 includes naphtha consisting of 36% normal-paraffins, 37% iso-paraffins, 21% naphthenes, and 6% aromatics, and is diluted with the dilution steam 508 in a ratio of about 0.4 kilograms (kg) steam/kg naphtha, preheated to about 650 degrees C., and fed to the cracking coils 516 of a cracking furnace 502, where it pyrolyzes at a coil outlet temperature of about 800 degrees C. and a coil outlet pressure of about 2 bar absolute. The separated by-product methane enters a system including the first and second methane pyrolyzers 532a and 532b arranged in a parallel flow configuration, for example, as shown in FIG. 10. In the embodiment shown, the first and second methane pyrolyzers 532a and 532b may be periodically heated by combustion of hydrogen, for example, obtained from the quench, compression, and separation section 518. The demand of hydrogen as internal fuel for the first and second methane pyrolyzers 532a and 532b may be approximated from a steady-state heat balance, for example, under an assumption that both the first methane pyrolyzer 532a (e.g., operating in methane-splitting mode) and the second methane pyrolyzer 532b (e.g., operating in re-heating mode) operate at about 1,066 degrees C., and the gaseous inlet and outlet streams exchange heat with each other. Such an example arrangement may require combustion of about 0.142 kg hydrogen/kg methane, substantially equivalent to about 0.019 kg hydrogen/kg naphtha, to split the by-product methane into about 0.033 kg hydrogen/kg naphtha and about 0.099 kg carbon black/kg naphtha. The remainder of about 0.014 kg hydrogen/kg naphtha, or about 43% of the hydrogen produced in the first methane pyrolyzer 532a, which may not be required for re-heating pyrolyzer 532b, may be used as fuel for the cracking furnace 502. About 0.78 MJ/kg naphtha heat may be generated and may be recovered from a carbon black cooler at approximately 1,000 degrees C. About 0.071 kg biogas/kg naphtha (e.g., as methane) may be required to be added to the system 500 in order to fulfill the heating demand of the co-fired cracking furnace 502. A cracking furnace for converting about 24 t/h naphtha feed may need, for example, the addition of about 1.70 t/h bio-gas.

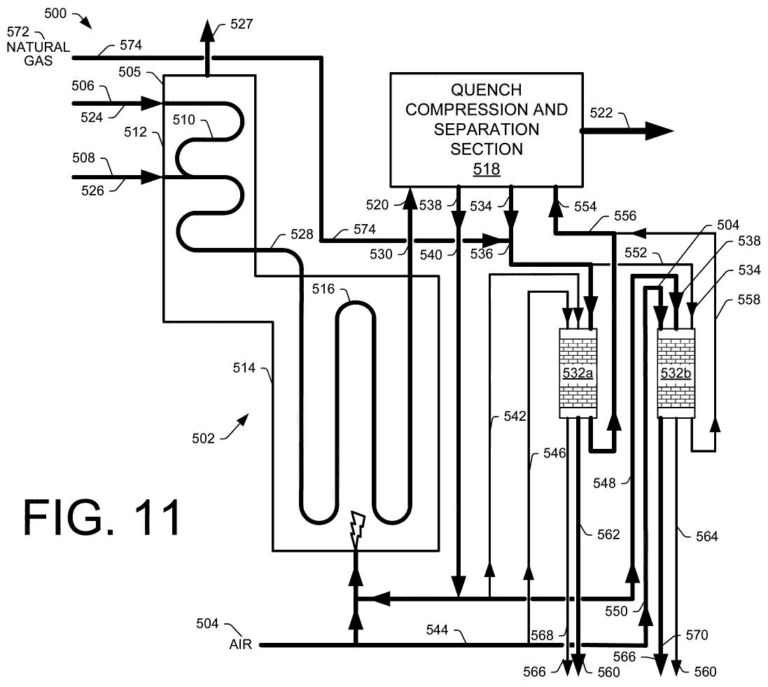

FIG. 11 schematically illustrates an example system 500 for producing olefins from naphtha or ethane consistent with the system of FIG. 9 according to embodiments of the disclosure. As shown in FIG. 11, the example system 500 includes a gas-fired steam cracking furnace 502 heated by combustion of fuel, such as, for example, hydrogen from splitting both by-product methane and natural gas supplied, for example, from a source independent from (e.g., outside) the system 500. The embodiment shown in FIG. 11 is similar to the embodiment shown in FIG. 10, except that natural gas 572 (e.g., added natural gas) is supplied to the first methane pyrolyzer 532a in methane splitting mode via an inlet line 574 and line 536, for example, as shown in FIG. 11.

In a twelfth example according to embodiments of the disclosure and consistent with the example system 500 shown in FIG. 11, naphtha is cracked by a cracking furnace 502 heated by the combustion of hydrogen obtained from splitting of both by-product methane and the natural gas 572 supplied from a source independent from the system 500. For example, naphtha is cracked in the cracking furnace 502, for example, in a manner at least to similar to the manner described with respect to the ninth example, except in the twelfth example, the cracking furnace 502 is heated by combustion of hydrogen only (although trace amounts of other fuel may be present). The product mixture 520 (e.g., the cracking products) may be separated in the quench, compression, and separation section 518 of the system 500, for example, as will be understood by those skilled in the art. The flue gas 527 from the cracking furnace 502 may be released to the atmosphere and may contain carbon dioxide only in trace amounts, if at all.

In the twelfth example, the separated by-product methane may be mixed with the natural gas 572 (e.g., as methane) and enters a system of the first and second methane pyrolyzers 532a and 532b, which may be provided in a parallel flow configuration, for example, as shown in FIG. 11. In the embodiment shown, the first and second methane pyrolyzers 532a and 532b may be periodically heated by combustion of hydrogen, for example, obtained from the quench, compression, and separation section 518. The ratio of imported natural gas and by-product methane may be selected to generate a sufficient amount of hydrogen by methane pyrolysis, such that the complete heating demand of the cracking furnace 502 and of the first and/or second methane pyrolyzer 532a and/or 532b may be fulfilled by combustion of hydrogen.

Such an example arrangement may require combustion of about 0.142 kg hydrogen/kg methane, equivalent to about 0.052 kg hydrogen/kg naphtha, to split the mixture of natural gas 572 and by-product methane into about 0.093 kg hydrogen/kg naphtha and about 0.276 kg carbon black/kg naphtha. The remainder of about 0.040 kg hydrogen/kg naphtha, or about 44% of the hydrogen produced in the first methane pyrolyzer 532a, which may not be required for re-heating the second methane pyrolyzer 532b, may be used as fuel for the cracking furnace. About 2.16 MJ/kg naphtha heat may be generated and may be recovered from a carbon black cooler at approximately 1,000 degrees C. About 0.236 kg natural gas/kg naphtha (e.g., as methane) may be required to be added to the system 500 in order to fulfill the heating demand of the hydrogen-fired cracking furnace 502. A cracking furnace for converting about 24 t/h naphtha feed may need, for example, the addition of about 5.67 t/h natural gas.

In a thirteenth example according to embodiments of the disclosure and consistent with the example system 500 shown in FIG. 10, ethane is cracked by a cracking furnace 502 heated by the combustion of a mixture of hydrogen split from by-product methane and bio-gas 503 supplied from a source independent from the system 500. For example, ethane is cracked in the cracking furnace 502 in a manner at least similar to the manner described with respect to the tenth example, except that in the thirteenth example, the cracking furnace 502 is heated by combustion of a mixture of hydrogen obtained from the cracking process and bio-gas 503. In some embodiments, a majority of the product mixture 520 (e.g., the cracking products) is separated in the quench, compression, and separation section 518 of the system 500 as will be understood by those skilled in the art, and by-product methane and hydrogen are not separated from each other. The flue gas 527 from the cracking furnace 502 released to the atmosphere contains carbon dioxide, which results from combustion of the bio-gas 503.

In the thirteenth example, the separated mixture of by-product methane and hydrogen may enter a system including the first and second methane pyrolyzers 532a and 532b arranged in a parallel flow configuration, for example, as shown in FIG. 10. In the embodiment shown, the first and second methane pyrolyzers 532a and 532b may be periodically heated by combustion of hydrogen, for example, obtained from the quench, compression, and separation section 518. Such an example arrangement may require combustion of about 0.147 kg hydrogen/kg methane, equivalent to about 0.008 kg hydrogen/kg C₂ converted, to split the by-product methane into about 0.015 kg hydrogen/kg C₂ converted and about 0.043 kg carbon black/kg C₂ converted. The remainder of 0.062 kg hydrogen/kg C₂ converted, which is not needed for re-heating the second methane pyrolyzer 532b, may be used as fuel for the cracking furnace 502. About 0.34 MJ/kg C₂ converted heat are generated and may be recovered from the carbon black cooler at approximately 1,000 degrees C. About 0.130 kg biogas/kg C₂ converted (e.g., as methane) may be required to be added to the system 500 in order to fulfill the heating demand of the co-fired cracking furnace 502. A cracking furnace for converting about 30 t/h ethane feed may need, for example, the addition of about 2.54 t/h bio-gas.

In a fourteenth example according to embodiments of the disclosure and consistent with the example system 500 shown in FIG. 11, ethane is cracked by a cracking furnace 502 heated by the combustion of hydrogen only (although trace amounts of other fuel may be present). For example, ethane is cracked in the cracking furnace 502 in a manner at least similar to the manner described with respect to the tenth example, except that the cracking furnace 502 is heated by the combustion of hydrogen from the splitting of both by-product methane from the cracking furnace 502 and the natural gas 572 obtained from a source independent of the system 500. A majority of the product mixture 520 (e.g., the cracking products) may be separated in the quench, compression, and separation section 518 of the system 500, for example, as will be understood by those skilled in the art. The by-product methane and hydrogen from the cracking furnace 502 may not be separated from one another in the quench, compression, and separation section 518. The flue gas 527 from the cracking furnace 502 may be released to the atmosphere and may contain carbon dioxide only in trace amounts, if at all.

As shown in FIG. 11, the separated mixture of by-product hydrogen and methane 534 is mixed with the natural gas 572 (e.g., as methane), for example, in line 536 and is supplied to the first pyrolyzer 532a in methane splitting mode as shown in FIG. 11. In the embodiment shown, the first and second methane pyrolyzers 532a and 532b may be periodically heated by combustion of hydrogen, for example, obtained from the quench, compression, and separation section 518. The ratio of imported natural gas 572 and by-product methane may be selected to generate a sufficient amount of hydrogen by methane pyrolysis, such that substantially the complete heating demand of the cracking furnace 502 and the methane pyrolyzer 532b in re-heating mode may be fulfilled by combustion of hydrogen. Such an example arrangement may require combustion of about 0.143 kg hydrogen/kg methane, equivalent to about 0.070 kg hydrogen/kg C₂ converted, to split the mixture of by-product methane and natural gas 572 obtained by an independent source into about 0.123 kg hydrogen/kg C₂ converted and 0.366 kg carbon black/kg C₂ converted. About 2.86 MJ/kg C₂ converted heat are generated and may be recovered from the carbon black cooler at approximately 1,000 degrees C. About 0.430 kg natural gas/kg C₂ converted (e.g., as methane) may be required to be added to the system 500 in order to fulfill the heating demand of the hydrogen-fired cracking furnace 502. A cracking furnace for converting about 30 t/h ethane feed may need, for example, the addition of 8.39 t/h natural gas.

In some embodiments consistent with FIGS. 10 and 11, the system 500 may include one or more controllers configured to control operation of the pre-heating section 512, the cracking furnace 502, the quench, compression, and separation section 518, and/or the first and second methane pyrolyzers 532a and 532b, for example, as will be understood by those skilled in the art. For example, the system 500 may include a plurality of temperature sensors, pressure sensors, flow rate sensors, etc., in communication with the controller, and the controller may use control logic in the form of computer software and/or hardware programs to make control decisions associated with controlling operation of the pre-heating section 512, the cracking furnace 502, the quench, compression, and separation section 518, the first and second methane pyrolyzers 532a and 532b, and/or components thereof. In some embodiments, the system 500 may include valves associated with the lines and/or conduits, and the controller may communicate control signals based at least in part on the control decisions to actuators associated with the valves to control the flow of fluid (e.g., gases and/or liquids) and/or heat, and the actuators may be operated according to the communicated control signals to operate the parts of the system 500. In some examples, the controller may be supplemented or replaced by human operators at least partially manually controlling the system 500 to meet desired performance parameters based at least in part on efficiency considerations and/or emissions considerations.

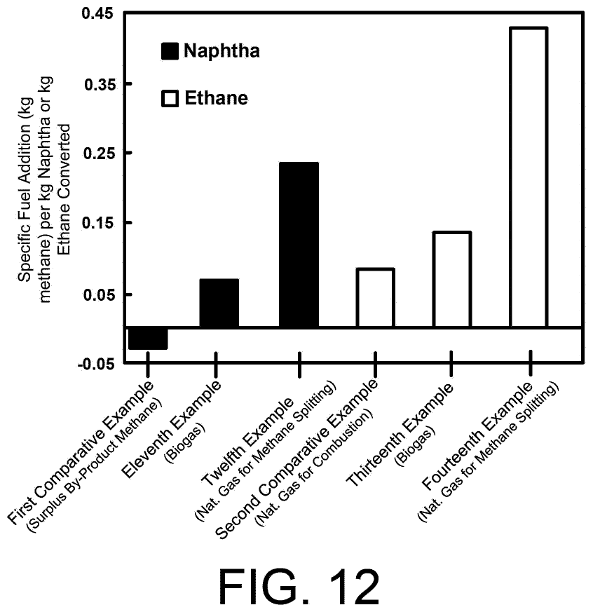

FIG. 12 is a bar graph showing specific fuel addition for the first and second comparative examples of FIG. 2 and the eleventh through fourteenth examples of FIGS. 10 and 11 according to embodiments of the disclosure. As shown in FIG. 12, the specific fuel added (e.g., methane in kilograms) to the system 100 (FIG. 2) or 500 (FIGS. 10 and 11) per kilogram naphtha or kilogram ethane converted by the example olefin plant varies based on the example parameters varied for each of the first and second comparative examples and the eleventh through fourteenth examples. Referring to the first and second comparative examples, which both heat the cracking furnace by combustion of hydrocarbons, but which do not include a methane pyrolyzer, the first comparative example exhibits a negative specific addition of fuel in the form of surplus methane not needed for combustion during conversion of a naphtha feed, while the second comparative example requires the addition of fuel in the form of methane during the conversion of ethane from an ethane feed, tending to indicate less fuel needs to be added for the naphtha feed conversion relative to the ethane feed conversion.

The eleventh and thirteenth examples, differ only in that the eleventh example has a naphtha feed while the thirteenth example has an ethane feed, shows that relatively less fuel needs to be added per kilogram of naphtha converted for the example system 500 shown in FIG. 10. Similarly, the twelfth and fourteenth examples, which differ only in that the twelfth example has a naphtha feed while the fourteenth example has an ethane feed, shows that relatively more fuel needs to be added per kilogram of ethane converted for the example system 500 shown in FIG. 11. The eleventh and thirteenth examples, which both heat the cracking furnace 502 by the combustion to hydrogen obtained from the cracking process by splitting by-product methane in combination with bio-gas supplied to the system 500, require relatively less specific fuel addition than the twelfth and fourteenth examples, which both heat the cracking furnace 502 by the combustion of hydrogen obtained from the cracking process by splitting by-product methane in combination with natural gas supplied to the system 500, the difference being the addition bio-gas of the thirteenth example as compared to the addition of natural gas of the fourteenth example. This may be interpreted in economic terms, that biogas 503 from sources independent of system 500 may be three times (for naphtha feed) to five times (for ethane feed) more expensive than natural gas 572 from sources independent of system 500 for the same total variable cost for fuel, and without net emissions of carbon dioxide from fossil sources in flue gas 527, if all carbon contained in biogas 503 is allocated to the carbon dioxide content of flue gas 527 in the eleventh and thirteenth example.

An example system A to produce olefins may include one or more pre-heating assemblies to heat one or more of a hydrocarbon feed or dilution steam and one or more cracking furnaces in flow communication with at least one of the one or more pre-heating assemblies, at least one of the one or more cracking furnaces being at least partially powered by electricity to generate heat to at least partially crack the hydrocarbon feed into at least partially cracked hydrocarbons comprising olefins and methane. The system also may include one or more pyrolyzers in flow communication with at least one of the one or more cracking furnaces to split methane from the at least partially cracked hydrocarbons into carbon black and hydrogen. The system further may include one or more converters in flow communication with at least one of the one or more pyrolyzers, the one or more converters being positioned to convert hydrogen into electricity, and at least one of the one or more cracking furnaces being at least partially powered by electricity and being positioned to receive electricity from one or more of the one or more converters.

The example system A above, wherein at least one of the one or more pre-heating assemblies may be in flow communication with one or more of (i) at least one of the one or more converters or (ii) at least one of the one or more pyrolyzers and may be positioned to receive high temperature heat from one or more of the one or more converters or the one or more pyrolyzers.

The example system A above, wherein at least one of the one or more converters may include one or more fuel cells to convert hydrogen into electricity, the one or more fuel cells being in flow communication with the one or more pyrolyzers to receive hydrogen from the one or more pyrolyzers, convert at least a portion of the hydrogen into electricity, and supply at least a portion of the electricity to the one or more cracking furnaces.

The example system A above, further including one or more electric generators, wherein at least one of the one or more converters may include one or more gas turbines to produce mechanical work, at least one of the one or more gas turbines being connected to at least one of the one or more electric generators to convert at least a portion of the mechanical work into electricity.

The example system A above, further including one or more quench, compression, and separation sections in flow communication with at least one of the one or more cracking furnaces, at least one of the one or more quench, compression, and separation sections being configured to receive at least a portion of the mechanical work from at least one of the one or more gas turbines and being configured to separate methane and hydrogen from the at least partially cracked hydrocarbons.

The example system A above, wherein the one or more converters may include one or more of one or more fuel cells or one or more gas turbines, the one or more of one or more fuel cells or one or more gas turbines being configured to receive one or more of methane or hydrogen from the one or more pyrolyzers and convert the one or more of methane or hydrogen into electricity to supply one or more of the one or more pyrolyzers or the one or more cracking furnaces with electricity.

The example system A above, wherein at least one of the one or more cracking furnaces is configured to receive electricity from at least one of the one or more converters to provide electrical power for one or more electrical heaters to at least partially crack the hydrocarbon feed.

The example system A above, further including one or more quench, compression, and separation sections in flow communication with at least one of the one or more cracking furnaces and at least one of the one or more pyrolyzers, at least one of the one or more quench, compression, and separation sections being configured to separate methane and hydrogen from at least partially cracked hydrocarbons received from at least one of the one or more cracking furnaces.

The example system A above, wherein at least one of the one or more quench, compression, and separation sections includes a hydrogenation reactor in flow communication with at least one of the one or more pyrolyzers, the hydrogenation reactor being configured to use as a reactant hydrogen received from the at least one of the one or more pyrolyzers.

The example system A above, wherein at least one of the one or more pyrolyzers is configured to receive electricity from at least one of the one or more converters.

The example system A above, wherein at least one of the one or more pyrolyzers is configured to use at least a portion of hydrogen separated from the methane as fuel for the at least one pyrolyzer.

The example system A above, wherein at least one of the one or more converters includes one or more fuel cells configured to receive hydrogen from a hydrogen source independent from the system and convert into electricity at least a portion of the hydrogen received from the hydrogen source.

The example system A above, wherein at least one of the one or more converters includes one or more gas turbines to convert into mechanical work one or more of (i) natural gas received from a natural gas source independent from the system or (ii) biogas received from a biogas source independent from the system.

The example system A above, wherein at least one of the one or more converters is configured to receive air including nitrogen and oxygen and convert hydrogen and at least a portion of the air into electricity and water.

The example system A above, further including one or more quench, compression, and separation sections configured to receive the at least partially cracked hydrocarbons and separate olefins, methane, and hydrogen from the at least partially cracked hydrocarbons.

The example system A above, wherein at least one of the one or more pre-heating sections is in flow communication with at least one of the one or more quench, compression, and separation sections and is configured to receive condensed water from the at least one quench, compression, and separation section.

The example system A above, wherein at least one of the one or more pre-heating sections is configured to receive the hydrocarbon feed and the dilution steam, and output hydrocarbon vapor in steam.

The example system A above, wherein at least one of the cracking furnaces is configured to receive the hydrocarbon vapor in steam and at least partially crack the hydrocarbon vapor in steam into the at least partially cracked hydrocarbons including olefins and methane.

The example system A above, further including one or more quench, compression, and separation sections configured to receive the at least partially cracked hydrocarbons, at least one of the one or more quench, compression, and separation sections being in flow communication with the hydrocarbon feed and supplying hydrocarbons to the hydrocarbon feed.

An example method A for producing olefins may include supplying a hydrocarbon feed and dilution steam to a pre-heating assembly and heating the hydrocarbon feed and dilution steam via the pre-heating assembly to provide a heated hydrocarbon feed. The method also may include supplying the heated hydrocarbon feed to a cracking furnace at least partially powered by electricity to produce at least partially cracked hydrocarbons including olefins and methane. The method further may include one or more of compressing, condensing, or separating at least a portion of the at least partially cracked hydrocarbons to provide either a separate methane stream and a separate hydrogen stream or a mixed hydrogen and methane stream, and supplying the separate methane stream or the mixed hydrogen and methane stream to a pyrolyzer. The method also may include producing carbon black and hydrogen from the methane and hydrogen stream via the pyrolyzer, and supplying hydrogen from the pyrolyzer to a converter to convert the hydrogen into electricity. The method further may include supplying electricity from the converter to the cracking furnace, and supplying heat from one or more of the pyrolyzer or the converter to the pre-heating assembly.

The example method A above, wherein supplying hydrogen from the pyrolyzer to a converter to convert the hydrogen into electricity includes supplying the hydrogen from the pyrolyzer to one or more fuel cells to convert the hydrogen into electricity.

The example method A above, wherein supplying hydrogen from the pyrolyzer to a converter to convert the hydrogen into electricity includes supplying the hydrogen from the pyrolyzer to one or more gas turbines to produce mechanical work, and supplying the mechanical work to one or more electric generators to convert at least a portion of the mechanical work into electricity.

The example method A above, wherein compressing and separating at least a portion of the at least partially cracked hydrocarbons to provide a methane and hydrogen stream includes supplying at least a portion of the mechanical work produced by one or more gas turbines to a quench, compression, and separation section to separate methane and hydrogen from the at least partially cracked hydrocarbons.

The example method A above, wherein supplying hydrogen from the pyrolyzer to a converter to convert the hydrogen into electricity includes supplying the hydrogen from the pyrolyzer to one or more of one or more fuel cells or one or more gas turbines.

The example method A above, wherein supplying electricity from the converter to the cracking furnace includes converting hydrogen to electricity via one or more of (i) one or more fuel cells or (ii) one or more gas turbines connected to one or more electric generators.

The example method A above, further including supplying electricity to the cracking furnace from a source of electricity other than the converter.

The example method A above, wherein compressing and separating at least a portion of the at least partially cracked hydrocarbons includes supplying the at least partially cracked hydrocarbons to a hydrogenation reactor, and supplying hydrogen from the pyrolyzer to the hydrogenation reactor to use as a reactant hydrogen.

The example method A above, further including supplying electricity from the converter to the pyrolyzer.

The example method A above, further including supplying at least a portion of hydrogen formed from methane by the pyrolyzer as fuel to the pyrolyzer.

The example method A above, wherein the converter includes a fuel cell, and the method further includes supplying external hydrogen to the fuel cell from a hydrogen source independent from hydrogen provided by the cracking furnace, a quench, compression, and separation section, or the pyrolyzer, and converting the external hydrogen into electricity via the fuel cell.

The example method A above, wherein the converter includes one or more gas turbines, and the method further includes converting into mechanical work via the one or more gas turbines one or more of (i) natural gas received from a natural gas source or (ii) biogas received from a biogas source.

The example method A above, further including converting hydrogen and air including nitrogen and oxygen into electricity and water.

The example method A above, wherein compressing and separating at least a portion of the at least partially cracked hydrocarbons includes separating olefins, methane, and hydrogen from the at least partially cracked hydrocarbons.

The example method A above, wherein compressing and separating at least a portion of the at least partially cracked hydrocarbons results in condensed water, and the method further includes supplying the condensed water to the pre-heating assembly.

The example method A above, wherein heating the hydrocarbon feed and dilution steam via the pre-heating assembly provides hydrocarbon vapor in steam.

The example method A above, wherein supplying the heated hydrocarbon feed to a cracking furnace includes supplying the hydrocarbon vapor in steam to the cracking furnace.

The example method A above, further including supplying a portion of the at least partially cracked hydrocarbons from the cracking furnace to the hydrocarbon feed.

An example system B to produce olefins may include one or more pre-heating assemblies to heat one or more of a hydrocarbon feed or dilution steam, and one or more cracking furnaces in flow communication with at least one of the one or more pre-heating assemblies, at least one of the one or more cracking furnaces being at least partially powered by hydrogen (e.g., heated by hydrogen combustion) to generate heat to at least partially crack the hydrocarbon feed into at least partially cracked hydrocarbons including olefins and methane. The example system further may include one or more pyrolyzers in flow communication with at least one of the one or more cracking furnaces to split methane from the at least partially cracked hydrocarbons into carbon black and hydrogen, at least a portion of the hydrogen from the one or more pyrolyzers being supplied to at least one of the one or more cracking furnaces as fuel.

The example system B above, wherein at least one of the one or more pre-heating assemblies is in flow communication with at least one of the one or more pyrolyzers, and the at least one pre heating assembly is configured to receive heat from the at least one pyrolyzer to heat the hydrocarbon feed and dilution steam.

The example system B above, wherein at least one of the one or more cracking furnaces is configured to receive as fuel one or more of (i) natural gas received from a natural gas source independent from the system or (ii) biogas received from a biogas source independent from the system.

The example system B above, further including one or more quench, compression, and separation sections in flow communication with one or more of (i) at least one of the one or more cracking furnaces or (ii) at least one of the one or more pyrolyzers.

The example system B above, wherein at least one of the one or more quench, compression, and separation sections is configured to separate methane and hydrogen from the at least partially cracked hydrocarbons received from at least one of the one or more cracking furnaces.

The example system B above, wherein at least one of the one or more quench, compression, and separation sections includes a hydrogenation reactor configured to receive hydrogen output from at least one of the one or more pyrolyzers for use as a reactant.

The example system B above, wherein at least one of the one or more pyrolyzers is configured to use as fuel natural gas received from a natural gas source independent from the system.

The example system B above, wherein at least one of the one or more pyrolyzers is configured to use non-fossil electricity.

An example method B for producing olefins may include supplying a hydrocarbon feed and dilution steam to a pre-heating assembly, and heating the hydrocarbon feed and dilution steam via the pre-heating assembly to provide a heated hydrocarbon feed. The method further may include supplying the heated hydrocarbon feed to a cracking furnace at least partially powered by hydrogen to produce at least partially cracked hydrocarbons including olefins and methane, and one or more of compressing, condensing, or and separating at least a portion of the at least partially cracked hydrocarbons to provide either a separate methane stream and a separate hydrogen stream, or a mixed hydrogen and methane stream. The method also may include supplying the separate methane stream or the mixed hydrogen and methane stream to a pyrolyzer to provide carbon black and hydrogen, and supplying hydrogen from the pyrolyzer to the cracking furnace as fuel.

The example method B above, further including supplying heat from the pyrolyzer to the pre-heating assembly to heat the hydrocarbon feed and dilution steam.

The example method B above, further including supplying as fuel to the cracking furnace one or more of (i) natural gas received from a natural gas source independent from the hydrocarbon feed or (ii) biogas received from a biogas source independent from the hydrocarbon feed.

The example method B above, wherein compressing and separating at least a portion of the at least partially cracked hydrocarbons includes supplying the at least partially cracked hydrocarbons to a quench, compression, and separation section in flow communication with the cracking furnace, and supplying the methane and hydrogen stream to the pyrolyzer includes the supplying methane and hydrogen from the quench, compression, and separation section to the pyrolyzer.

The example method B above, wherein the quench, compression, and separation section includes a hydrogenation reactor, and the method further includes supplying to the hydrogenation reactor hydrogen output from the pyrolyzer for use as a reactant.

The example method B above, further including supplying as fuel to the pyrolyzer natural gas received from a natural gas source independent from the hydrocarbon feed.

The example method B above, further including supplying non-fossil electricity to the pyrolyzer.

Having now described some illustrative embodiments of the disclosure, it should be apparent to those skilled in the art that the foregoing is merely illustrative and not limiting, having been presented by way of example only. Numerous modifications and other embodiments are within the scope of one of ordinary skill in the art and are contemplated as falling within the scope of the disclosure. In particular, although many of the examples presented herein involve specific combinations of method acts or system elements, it should be understood that those acts and those elements may be combined in other ways to accomplish the same objectives. Those skilled in the art should appreciate that the parameters and configurations described herein are exemplary and that actual parameters and/or configurations will depend on the specific application in which the systems and techniques of the invention are used. Those skilled in the art should also recognize or be able to ascertain, using no more than routine experimentation, equivalents to the specific embodiments of the invention. It is, therefore, to be understood that the embodiments described herein are presented by way of example only and that, within the scope of any appended claims and equivalents thereto, the embodiments of the disclosure may be practiced other than as specifically described.

Furthermore, the scope of the present disclosure shall be construed to cover various modifications, combinations, additions, alterations, etc., above and to the above-described embodiments, which shall be considered to be within the scope of this disclosure. Accordingly, various features and characteristics as discussed herein may be selectively interchanged and applied to other illustrated and non-illustrated embodiment, and numerous variations, modifications, and additions further can be made thereto without departing from the spirit and scope of the present invention as set forth in the appended claims.

1-15. (canceled)

16. A system to produce olefins, the system comprising:
one or more pre-heating assemblies to heat one or more of a hydrocarbon feed or dilution steam;
one or more cracking furnaces in flow communication with at least one of the one or more pre-heating assemblies, at least one of the one or more cracking furnaces being at least partially powered by hydrogen to generate heat to at least partially crack the hydrocarbon feed into at least partially cracked hydrocarbons comprising olefins and methane; and
one or more pyrolyzers in flow communication with at least one of the one or more cracking furnaces to split methane from the at least partially cracked hydrocarbons into carbon black and hydrogen, at least a portion of the hydrogen from the one or more pyrolyzers being supplied to at least one of the one or more cracking furnaces as fuel.

17. The system of claim 16, further comprising:
one or more quench, compression, and separation sections in flow communication with one or more elements selected from the group of elements consisting of: (i) at least one of the one or more cracking furnaces, and (ii) at least one of the one or more pyrolyzers;
where the system is configured with at least one feature selected from the group of features consisting of: (a) at least one of the one or more quench, compression, and separation sections is configured to separate methane and hydrogen from the at least partially cracked hydrocarbons received from at least one of the one or more cracking furnaces; and (b) at least one of the one or more quench, compression, and separation sections comprises a hydrogenation reactor configured to receive hydrogen output from at least one of the one or more pyrolyzers for use as a reactant.

18. A method for producing olefins, the method comprising:
supplying a hydrocarbon feed and dilution steam to a pre-heating assembly;
heating the hydrocarbon feed and dilution steam via the pre-heating assembly to provide a heated hydrocarbon feed;
supplying the heated hydrocarbon feed to a cracking furnace at least partially powered by hydrogen to produce at least partially cracked hydrocarbons comprising olefins and methane;
performing one or more actions on at least a portion of the at least partially cracked hydrocarbons to provide either (a) a separate methane stream and a separate hydrogen stream, or (b) a mixed hydrogen and methane stream; where the one or more actions are selected from the group of actions consisting of: compressing, condensing, and separating;
supplying the separate methane stream or the mixed hydrogen and methane stream to a pyrolyzer to provide carbon black and hydrogen; and
supplying hydrogen from the pyrolyzer to the cracking furnace as fuel.

19. The method of claim 18, further comprising:
supplying as fuel to the cracking furnace one or more of (i) natural gas received from a natural gas source independent from the hydrocarbon feed or (ii) biogas received from a biogas source independent from the hydrocarbon feed.

20. The method of claim 18, wherein:
performing the one or more actions comprises supplying the at least partially cracked hydrocarbons to a quench, compression, and separation section in flow communication with the cracking furnace; and
supplying the methane and hydrogen stream to the pyrolyzer comprises the supplying methane and hydrogen from the quench, compression, and separation section to the pyrolyzer; and
the quench, compression, and separation section comprises a hydrogenation reactor, and the method further comprises supplying to the hydrogenation reactor hydrogen output from the pyrolyzer for use as a reactant.

21. A system to produce olefins, the system comprising:
one or more pre-heating assemblies to heat one or more of a hydrocarbon feed or dilution steam;
one or more cracking furnaces in flow communication with at least one of the one or more pre-heating assemblies, at least one of the one or more cracking furnaces being at least partially powered by electricity to generate heat to at least partially crack the hydrocarbon feed into at least partially cracked hydrocarbons comprising olefins and methane;
one or more pyrolyzers in flow communication with at least one of the one or more cracking furnaces to split methane from the at least partially cracked hydrocarbons into carbon black and hydrogen; and
one or more converters in flow communication with at least one of the one or more pyrolyzers, the one or more converters being positioned to convert hydrogen into electricity, and at least one of the one or more cracking furnaces being at least partially powered by electricity and being positioned to receive electricity from one or more of the one or more converters.

22. The system of claim 21, wherein at least one of the one or more pre-heating assemblies is in flow communication with one or more of (i) at least one of the one or more converters or (ii) at least one of the one or more pyrolyzers and is positioned to receive high-temperature heat from one or more of the one or more converters or the one or more pyrolyzers.

23. The system of claim 21, wherein at least one of the one or more converters comprises one or more fuel cells to convert hydrogen into electricity, the one or more fuel cells being in flow communication with the one or more pyrolyzers to receive hydrogen from the one or more pyrolyzers, convert at least a portion of the hydrogen into electricity, and supply at least a portion of the electricity to the one or more cracking furnaces.

24. The system of claim 21, further comprising:
one or more electric generators, wherein at least one of the one or more converters comprises one or more gas turbines to produce mechanical work, at least one of the one or more gas turbines being connected to at least one of the one or more electric generators to convert at least a portion of the mechanical work into electricity.

25. The system of claim 21, wherein the one or more converters are selected from the group of converters consisting of: a fuel cell and a gas turbine, the one or more converters being configured to receive methane and/or hydrogen from the one or more pyrolyzers and convert the methane and/or hydrogen into electricity to supply electricity to one or more of the pyrolyzer(s) and/or to one or more of the cracking furnace(s).

26. The system of claim 21, wherein the system is configured with one or more features selected from the group of features consisting of:
at least one of the one or more cracking furnaces is configured to receive electricity from at least one of the one or more converters to provide electrical power for one or more electrical heaters to at least partially crack the hydrocarbon feed; and
at least one of the one or more pyrolyzers is configured to use at least a portion of hydrogen separated from the methane as fuel for the at least one pyrolyzer.

27. A method for producing olefins, the method comprising:
supplying a hydrocarbon feed and dilution steam to a pre-heating assembly;
heating the hydrocarbon feed and dilution steam via the pre-heating assembly to provide a heated hydrocarbon feed;
supplying the heated hydrocarbon feed to a cracking furnace at least partially powered by electricity to produce at least partially cracked hydrocarbons comprising olefins and methane;
performing one or more actions on at least a portion of the at least partially cracked hydrocarbons to provide either (a) a separate methane stream and a separate hydrogen stream, or (b) a mixed hydrogen and methane stream; where the one or more actions are selected from the group of actions consisting of: compressing, condensing, and separating;
supplying the separate methane stream or the mixed hydrogen and methane stream to a pyrolyzer to produce carbon black and hydrogen;
supplying hydrogen from the pyrolyzer to a converter to convert the hydrogen into electricity;
supplying electricity from the converter to the cracking furnace; and
supplying heat to the pre-heating assembly from the pyrolyzer and/or the converter.

28. The method of claim 27, wherein supplying hydrogen from the pyrolyzer to a converter to convert the hydrogen into electricity comprises one or more steps selected from the group of steps consisting of:
supplying the hydrogen from the pyrolyzer to one or more fuel cells to convert the hydrogen into electricity; and
supplying the hydrogen from the pyrolyzer to one or more gas turbines to produce mechanical work, and supplying the mechanical work to one or more electric generators to convert at least a portion of the mechanical work into electricity.

29. The method of claim 27, wherein performing the one or more actions comprises supplying at least a portion of the mechanical work produced by one or more gas turbines to a quench, compression, and separation section to separate methane and hydrogen from the at least partially cracked hydrocarbons.

30. The method of claim 27, wherein performing the one or more actions comprises:
supplying the at least partially cracked hydrocarbons to a hydrogenation reactor; and
supplying hydrogen from the pyrolyzer to the hydrogenation reactor to use as a reactant hydrogen.
